(19) United States
(12) Patent Application Publication
(10) Pub. No.: US 2025/0262878 A1
(43) Pub. Date: Aug. 21, 2025

(54) Liquid Ejecting Head And Liquid Ejecting Apparatus

(71) Applicant: SEIKO EPSON CORPORATION, Tokyo (JP)

(72) Inventors: Hiroaki OKUI, Azumino (JP); Shun KATSUIE, Matsumoto (JP); Hirokazu YANAGIHARA, Chino (JP); Ayumi YOKOO, Matsumoto (JP); Yu HASEGAWA, Shiojiri (JP)

(21) Appl. No.: 19/053,581

(22) Filed: Feb. 14, 2025

(30) Foreign Application Priority Data
Feb. 16, 2024 (JP) 2024-022209

(51) Int. Cl. B41J 25/34; B41J 2/175; B41J 3/54

(52) U.S. Cl. CPC B41J 25/34; B41J 2/175; B41J 3/543

(57) ABSTRACT

A liquid ejecting head includes head modules to eject a liquid in a first direction, and a metallic holder to which the head modules are fixed in a detachably-attached manner. Each of the head modules includes a metallic channel orifice forming member in which a channel is defined, and which includes a first alignment portion. The holder includes second alignment portions which are inserted into or receive the first alignment portions, respectively, in a press-fit manner, positioning the head modules with respect to the holder. A channel orifice formed in the holder to make a channel-forming connection to each of the head modules and a channel orifice formed in the head module to make the channel-forming connection to the holder coincide with each other as viewed in a direction in which either of the first alignment portions and the second alignment portions are press-fitted into the other alignment portions.

The present application is based on, and claims priority from JP Application Serial Number 2024-022209, filed Feb. 16, 2024, the disclosure of which is hereby incorporated by reference herein in its entirety.

### BACKGROUND

### 1. Technical Field

The present disclosure relates to a liquid ejecting head and a liquid ejecting apparatus.

### 2. Related Art

Heretofore, there have been proposed liquid ejecting apparatuses each including a liquid ejecting head to eject liquids such as inks to media such as print sheets.

A liquid ejecting head described in JP-A-2022-42753 includes multiple head chips (head modules), a fixing plate, and a holder. The multiple head chips are stored in a space surrounded by the fixing plate and the holder. The multiple head chips are aligned with the fixing plate and is fixed to the fixing plate with an adhesive. The fixing plate is fixed to the holder with the adhesive.

There is a demand to repair a liquid ejecting head, when one or some of the multiple head modules are broken, by detaching only the broken head modules and replacing them with new head modules. However, in the related art, in order to detach a head module from the holder, it is necessary to detach the fixing plate from the holder. This may result in disorder in the alignment of the multiple head modules with the fixing plate used as a reference. Therefore, there is a demand for a mechanism enabling multiple head modules included in a liquid ejecting head to be easily aligned in work of repairing the liquid ejecting head by replacing some of the multiple head modules.

### SUMMARY

A liquid ejecting head according to an aspect of the present disclosure includes a plurality of head modules each of which ejects a liquid in a first direction, and a metallic holder to which the plurality of head modules are fixed in a detachably-attached manner. Each of the plurality of head modules includes a metallic channel orifice forming member in which a channel is defined, and which includes a first alignment portion. The holder includes a plurality of second alignment portions which are inserted into or receive a plurality of the first alignment portions in a press-fit manner, thereby positioning the plurality of head modules with respect to the holder. A channel orifice formed in the holder and configured to make a channel-forming connection to each of the head modules and a channel orifice formed in the channel orifice forming member of the head module and configured to make the channel-forming connection to the holder coincide with each other as viewed in a direction in which either of the first alignment portions and the second alignment portions are press-fitted into the other alignment portions.

A liquid ejecting apparatus according to an aspect of the present disclosure includes a plurality of the liquid ejecting heads and a unit base that holds the plurality of liquid ejecting heads.

### BRIEF DESCRIPTION OF THE DRAWINGS

FIG. 1 is a schematic diagram illustrating a structural example of a liquid ejecting apparatus according to a first embodiment.

FIG. 2 is a plan view illustrating a liquid ejecting head illustrated in FIG. 1.

FIG. 3 is a cross-sectional view of the liquid ejecting head illustrated in FIG. 2 viewed along an X-axis direction.

FIG. 4 is a cross-sectional view of the liquid ejecting head illustrated in FIG. 2 viewed in a direction along a Y axis.

FIG. 5 is an underside view of the liquid ejecting head illustrated in FIG. 3.

FIG. 6 is a cross-sectional view of a chip included in a head module illustrated in FIG. 3.

FIG. 7 is a topside view of a channel orifice forming member included in the head module illustrated in FIG. 4.

FIG. 8 is an underside view of a holder and a relay substrate illustrated in FIG. 4.

FIG. 9 is a topside view of a holder illustrated in FIG. 4.

FIG. 10 is a plan view of a lower side of the holder illustrated in FIG. 4.

FIG. 11 is a topside view of seal members illustrated in FIG. 4.

FIG. 12 is a topside view of support members illustrated in FIG. 4.

FIG. 13 is a cross-sectional view of a part of a liquid ejecting head in a first modification.

FIG. 14 is a cross-sectional view of a part of a liquid ejecting head in a second modification.

FIG. 15 is a cross-sectional view of a part of a liquid ejecting head in a third modification.

FIG. 16 is a cross-sectional view of a part of a liquid ejecting head in a fourth modification.

FIG. 17 is a cross-sectional view of a part of a liquid ejecting head in a fifth modification.

FIG. 18 is a cross-sectional view of a part of a liquid ejecting head in a seventh modification.

FIG. 19 is a topside view of the liquid ejecting head in the seventh modification.

FIG. 20 is a cross-sectional view of a part of a liquid ejecting head in an eighth modification.

FIG. 21 is a topside view of the liquid ejecting head in the eighth modification.

FIG. 22 is a cross-sectional view of a part of a liquid ejecting head in a ninth modification.

FIG. 23 is a cross-sectional view illustrating a seal member and its surrounding area in a tenth modification.

FIG. 24 is a cross-sectional view of a part of a liquid ejecting head in the tenth modification.

FIG. 25 is a cross-sectional view illustrating a seal member and its surrounding area in an eleventh modification.

### DESCRIPTION OF EMBODIMENTS

Hereinafter, preferred embodiments of the present disclosure will be described with reference to the accompanying drawings. In the drawings, the dimensions and scale of each component are illustrated differently from actual ones as appropriate, and some parts of the drawings are schematically illustrated to facilitate understanding. The scope of the present disclosure is not limited to the following embodiments unless particularly limited in the following description. A phrase “an element β on an element Y” means not only a structure in which the element γ and the element β are in direct contact with each other, but also a structure in which the element γ and the element β are out of direct contact with each other. A phrase “an element γ and an element β are equal to each other” means that the element γ and the element β are substantially equal to each other, including a measurement error, a manufacturing error, or the like. A phrase “an element γ and an element β are the same as each other” means that the element γ and the element β are substantially the same as each other, including a measurement error, a manufacturing error, or the like.

### 1. First Embodiment

### 1-1. Overall Structure of Liquid Ejecting Apparatus 100

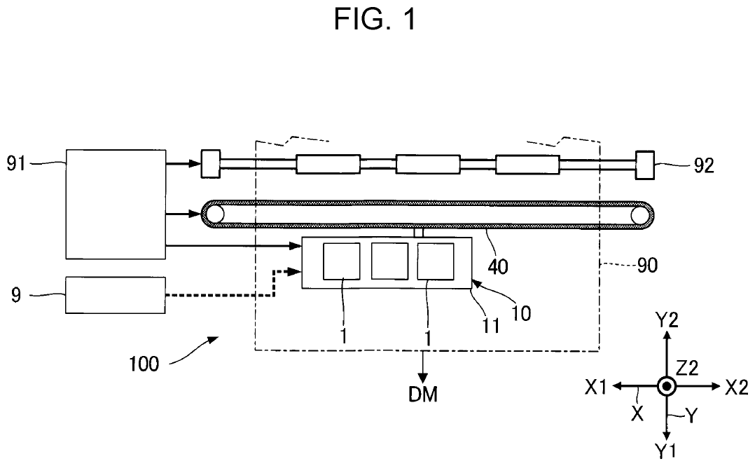

FIG. 1 is a schematic diagram illustrating a structural example of a liquid ejecting apparatus 100 according to a first embodiment. The following description will be given by using an X axis, a Y axis, and a Z axis, which are orthogonal to each other, as needed for convenience of description. Moreover, one of directions along the X axis is referred to as an X1 direction, and the direction opposite to the X1 direction is referred to as an X2 direction. Similarly, one of directions along the Y axis is referred to as a Y1 direction, and the direction opposite to the Y1 direction is referred to as a Y2 direction. One of directions along the Z axis is referred to as a Z1 direction, and the direction opposite to the Z1 direction is referred to as a Z2 direction. The Z1 direction is equivalent to a “first direction”. The Z2 direction is equivalent to “a second direction opposite to the first direction”. A side in the Z1 direction relative to a certain point in is referred to as a “lower side or underside”, whereas a side in the Z2 direction relative to the certain point is referred to as an “upper side or topside”. A view seen in the Z1 direction or the Z2 direction is referred to as a “plan view”.

As illustrated in FIG. 1, the liquid ejecting apparatus 100 includes a liquid reservoir section 9, a control unit 91, a transport section 92, a head unit 10, and a movement mechanism 40.

The liquid reservoir section 9 is a container for storing the ink. Examples of specific modes of the liquid reservoir section 9 include a cartridge removably mounted on the liquid ejecting apparatus 100, a bag-shaped ink pack formed of a flexible film, an ink tank refillable with the ink, and so on. The type of the ink stored in the liquid reservoir section 9 is not particularly limited and may be any type of ink.

The control unit 91 controls operations of elements in the liquid ejecting apparatus 100. The control unit 91 includes, for example, a processor circuit such as a central processing unit (CPU) or a field programmable gate array (FPGA) and a storage circuit such as a semiconductor memory, and controls the operations of the elements in the liquid ejecting apparatus 100.

The transport section 92 transports a medium 90 in a direction DM under the control of the control unit 91. In the present embodiment, the direction DM is the Y1 direction. In the example illustrated in FIG. 1, the transport section 92 includes a transport roller that is long along the X axis, and a motor that rotates the transport roller. The transport section 92 is not limited to a structure using the transport roller, and may have a structure using, for example, a drum or an endless belt that transports the medium 90 while adsorbing the medium 90 on its outer circumferential surface by electrostatic force or the like.

The movement mechanism 40 includes a transport belt to which a unit base 11 of the head unit 10 is fixed, and reciprocates the head unit 10 in the X1 and X2 directions under the control of the control unit 91. The head unit 10 ejects the ink supplied from the liquid reservoir section 9 to the medium 90 in the Z1 direction from each of multiple nozzles N under the control of the control unit 91. As a result of concurrent operations of the head unit 10 ejecting the ink and the movement mechanism 40 moving the head unit 10, an image is formed with the ink on a surface of the medium 90.

The number and layout of the multiple liquid ejecting heads 1 included in the head unit 10 are not limited to those in the example illustrated in FIG. 1 and may be determined as needed. In a case where the head unit 10 is configured to be able to circulate the ink, the head unit 10 may be connected to the liquid reservoir section 9 via a circulation mechanism for circulating the ink in the head unit 10.

### 1-2. Head Unit 10

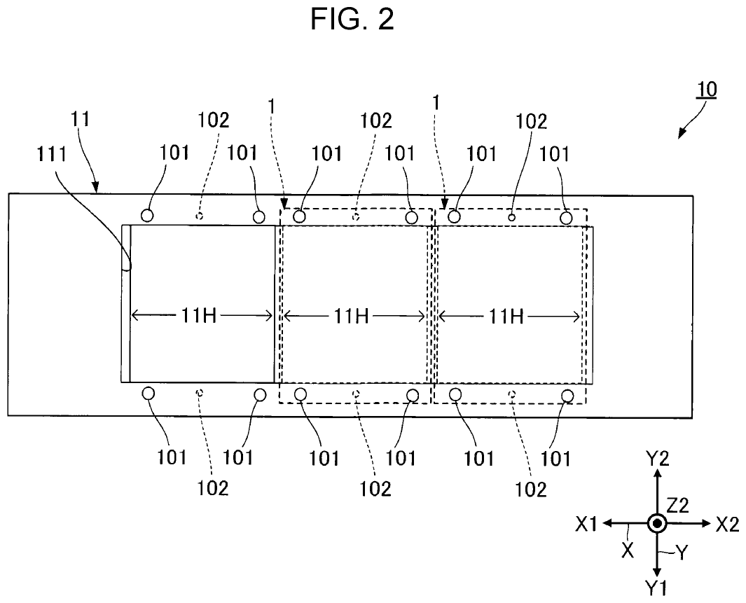

FIG. 2 is a plan view illustrating the head unit 10 illustrated in FIG. 1. As illustrated in FIG. 2, the head unit 10 includes the unit base 11 and the multiple liquid ejecting heads 1. The multiple liquid ejecting heads 1 are fixed to the unit base 11. The unit base 11 is a member that holds the multiple liquid ejecting heads 1. In the example illustrated, the number of liquid ejecting heads 1 for the unit base 11 is not particularly limited and may be any number equal to or more than 2.

The unit base 11 is, for example, a plate-shaped member whose thickness direction is a direction along the z axis. The unit base 11 is provided with a dented portion 111. The dented portion 111 is a recess provided in the unit base 11. The bottom surface of the dented portion 111 is provided with multiple through holes 11H. The planar shape of each through hole 11H is, for example, a rectangular shape. The through hole 11H is provided for each liquid ejecting head 1. A part of the liquid ejecting head 1 is inserted into each through hole 11H. In FIG. 2, one of the liquid ejecting heads 1 arranged in the unit base 11 is omitted from the illustration for the purpose of presenting the through hole 11H.

The unit base 11 is also provided with four mounting holes 101 and two third alignment portions 102 for each through hole 11H. The four mounting holes 101 and the two third alignment portions 102 are provided outside the through hole 11H in the plan view. Here, the numbers and the layout of the mounting holes 101 and the third alignment portions 102 are not limited to those illustrated in FIG. 2, but may be determined as needed.

The mounting holes 101 are provided, for example, near four corners of the through hole 11H in the plan view. The mounting holes 101 are used to mount the liquid ejecting head 1 on the unit base 11. For example, the mounting holes 101 penetrate the unit base 11 along the thickness direction.

For example, each of the third alignment portions 102 is provided between the two mounting holes 101 arranged in the direction along the X axis while being apart from these mounting holes 101. The third alignment portions 102 are used to position each liquid ejecting head 1 in mounting the liquid ejecting head 1 onto the unit base 11. Each third alignment portion 102 is, for example, a bottomed slot opened in a surface of the unit base 11 facing in the Z1 direction. Each third alignment portion 102 may be regarded as a dented portion formed in the surface of the unit base 11 facing in the Z1 direction.

Here, the mounting holes 101 do not have to penetrate the unit base 11 in the thickness direction. Likewise, the third alignment portions 102 may penetrate the unit base 11 in the thickness direction. The shape of the unit base 11 is not limited to the plate shape, and may be a box shape.

As described above, the liquid ejecting apparatus 100 includes the multiple liquid ejecting heads 1 and the unit base 11 to which the multiple liquid ejecting heads 1 are fixed. Such liquid ejecting apparatus 100 includes the liquid ejecting heads 1 to be described later. As will be described later, the multiple liquid ejecting heads 1 can be each detachably mounted on the unit base 11, and are configured such that the alignment of the multiple liquid ejecting heads 1 with high precision can be achieved. For this reason, even if any of the multiple liquid ejecting heads 1 is replaced, the liquid ejecting apparatus 100 is capable of keeping the print quality from deteriorating.

### 1-3. Liquid Ejecting Head 1

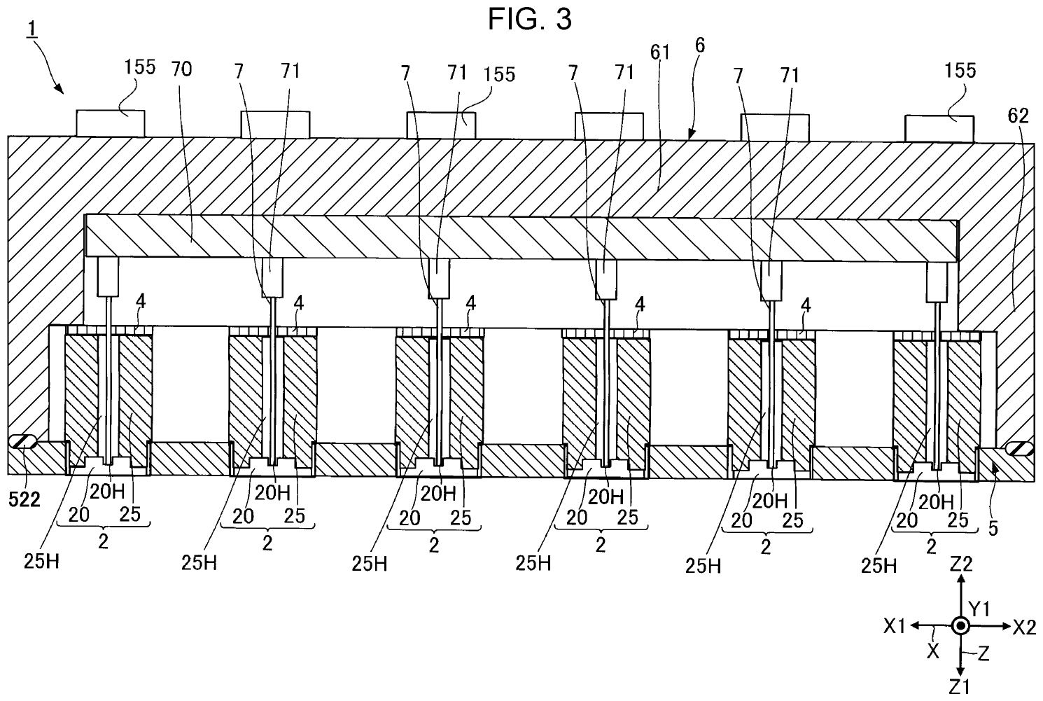

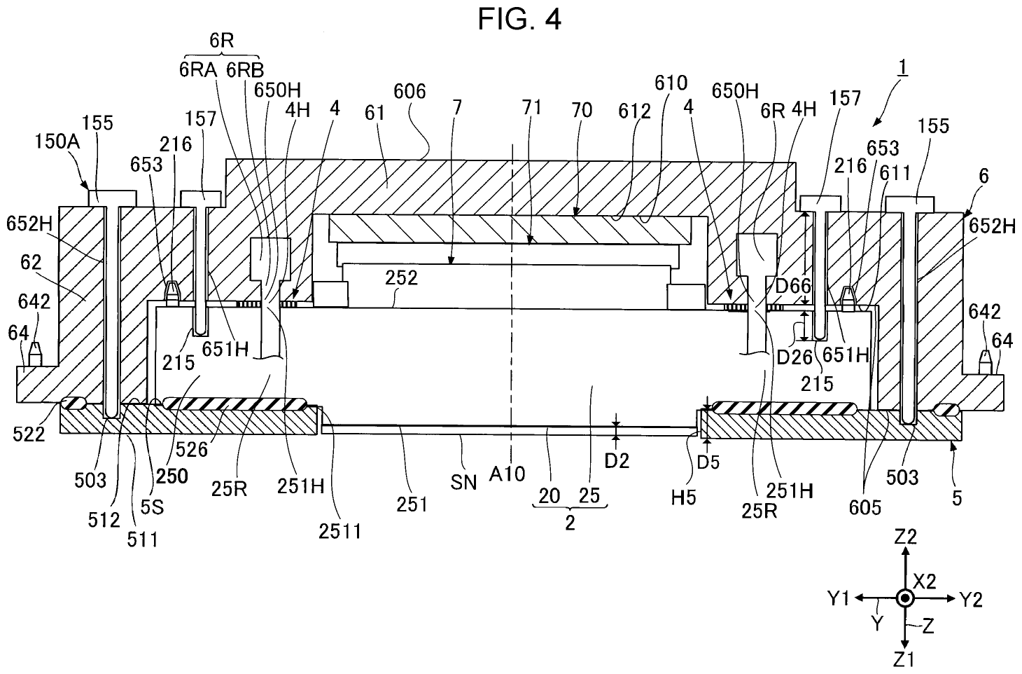

FIG. 3 is a cross-sectional view of the liquid ejecting head 1 illustrated in FIG. 2 viewed in the direction along the X axis. FIG. 4 is a cross-sectional view of the liquid ejecting head 1 illustrated in FIG. 2 viewed in the direction along the Y axis. As illustrated in FIG. 4, in the present embodiment, the liquid ejecting head 1 has a structure approximately symmetrical about a central imaginary plane A10 along an X-Z plane. However, the liquid ejecting head 1 may have a structure other than the structure symmetrical about the central imaginary plane A10.

As illustrated in any of FIGS. 3 and 4, the liquid ejecting head 1 includes multiple head modules 2, seal members 4, multiple covers 5, the holder 6, multiple wiring substrates 7, and a relay substrate 70.

In the liquid ejecting head 1, the cover 5, the holder 6, and the multiple head modules 2 can be detachably attached to each other. After the cover 5 is detached from the holder 6, each of the head modules 2 can be individually detached from the holder 6. Since each head module 2 can be detached from the holder 6, each head module 2 is replaceable.

### 1-3A. Head Module 2

In the example in FIG. 3, the multiple head modules 2 are six head modules 2. The number of head modules 2 is not limited to six, but may be any number of two to five or seven or more.

In the present embodiment, the multiple head modules 2 are next to each other along the X axis. As illustrated in FIG. 4, each head module 2 is long along the Y axis. Each head module 2 ejects the ink in the Z1 direction. Each head module 2 includes a chip 20 and a channel orifice forming member 25. The chip 20 is arranged in the Z1 direction relative to the channel orifice forming member 25.

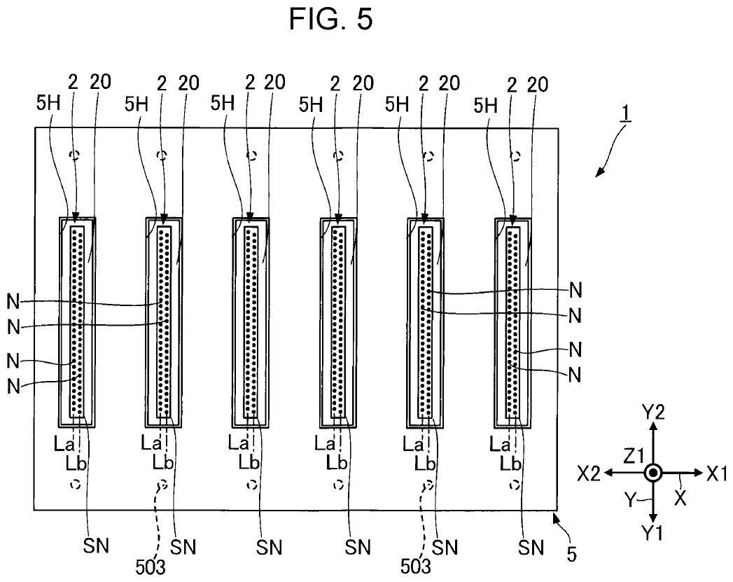

FIG. 5 is an underside view of the liquid ejecting head 1 illustrated in FIG. 3. As illustrated in FIG. 5, each head module 2 includes multiple nozzles N to eject the ink. The multiple nozzles N are arrayed along the Y axis. The multiple nozzles N are divided into a nozzle array La and a nozzle array Lb arranged side by side while being spaced out along the X axis. Each of the nozzle array La and the nozzle array Lb is a set of multiple nozzles N arrayed linearly along the Y axis. A surface of the head module 2 in which the orifices of the multiples nozzles N are formed is referred to as a nozzle surface SN. The nozzle surface SN is a surface of the chip 20 of the head module 2 facing in the Z1 direction. Alternatively, for example, the multiple nozzles N may be arrayed in a direction crossing the X axis and the Y axis as viewed in the Z1 direction.

1-3Aa. Chip 20

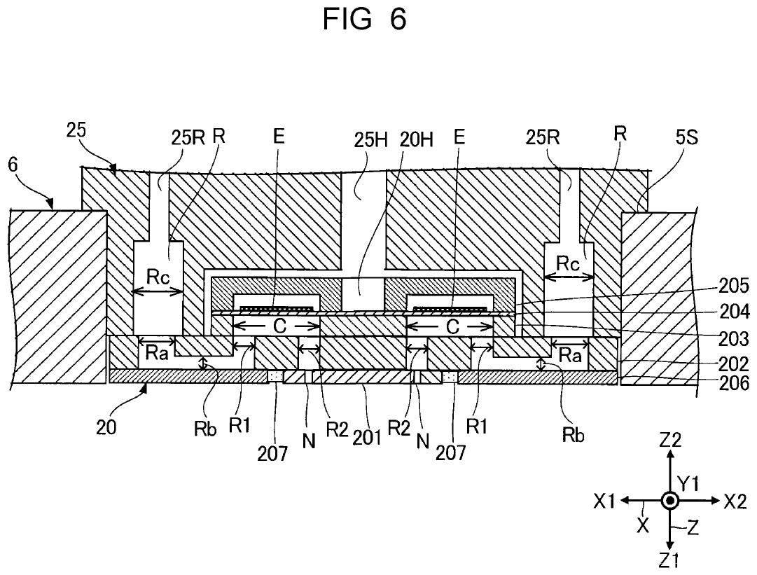

FIG. 6 is a cross sectional view of the chip 20 included in the head module 2 illustrated in FIG. 3. The chip 20 has a structure in which elements related to the nozzles N of the nozzle array La are arranged in plane symmetry with elements related to the nozzles N of the nozzle array Lb. In the following description, the elements for the nozzle array La will be mainly described and description of the elements for the nozzle array Lb will be omitted if unnecessary. In addition, the nozzle array La and the nozzle array Lb will be referred to as a nozzle array L below if there is no need to distinguish between them.

As illustrated in FIG. 6, the chip 20 of each head module 2 includes, for example, a communication plate 202, a pressure chamber substrate 203, a vibration plate 204, a nozzle plate 201, a cover 206, multiple driver elements E, and a sealing substrate 205.

Each of the communication plate 202, the pressure chamber substrate 203, the vibration plate 204, the nozzle plate 201, and the cover 206 is a plate-shaped member that is long along the Y axis. The pressure chamber substrate 203 is provided on a surface of the communication plate 202 facing in the Z2 direction. The nozzle plate 201 and the cover 206 are provided on a surface of the communication plate 202 facing in the Z1 direction. For example, these members are fixed to each other with an adhesive.

The nozzle plate 201 is a plate-shaped member in which the multiple nozzles N are formed. The nozzle plate 201 is the outermost member in the Z1 direction in the head module 2. A surface of the nozzle plate 201 facing in the Z1 direction serves as the nozzle surface SN. Each of the multiple nozzles N is a circular through hole to eject the ink. For example, the nozzle plate 201 is produced by processing a single crystal substrate of silicon (Si) with semiconductor manufacturing techniques such as photolithography and etching.

In the communication plate 202, multiple narrowed portions R1, multiple communication channels R2, a communication space Ra, and a common channel Rb are formed. Each of the narrowed portions R1 and the communication channels R2 is a through hole extended in the Z1 direction and formed for each nozzle N. The communication channels R2 coincide with the respective nozzles N in the plan view. The communication space Ra is a cavity formed in a shape long along the Y axis. The communication space Ra extends along the Y axis. The common channel Rb communicates with the communication space Ra and overlaps the communication space Ra in the plan view. The common channel Rb extends along the Y axis. The common channel Rb communicates with the multiple narrowed portions R1. The communication space Ra communicates with a space Rc included in the channel orifice forming member 25.

The communication space Ra, the common channel Rb, and the space Rc form a common space R provided in common to the multiple nozzles N. The common space R functions as a reservoir of the ink. The ink stored in the common space R is distributed to the narrowed portions R1 and is supplied to and filled in multiple pressure chambers C concurrently.

In the pressure chamber substrate 203, the multiple pressure chambers C are formed. Each of the pressure chambers C is a space located between the communication plate 202 and the vibration plate 204 and formed by wall surfaces of the pressure chamber substrate 203. One pressure chamber C is formed for each nozzle N. The pressure chamber C is a long space extended in the X1 direction. The multiple pressure chambers C are arrayed along the Y axis.

The communication plate 202 and the pressure chamber substrate 203 are each produced by, for example, processing a semiconductor substrate such as a single crystal substrate of silicon.

The vibration plate 204 elastically deformable is mounted on top of the pressure chamber C. The vibration plate 204 is stacked on the pressure chamber substrate 203 and is in contact with a surface of the pressure chamber substrate 203 opposite to the communication plate 202. The vibration plate 204 is a rectangular plate-shaped member that is long along the Y axis in the plan view. The pressure chamber C communicates with the nozzle N through the communication channel R2 and communicates with the communication space Ra through the narrowed portion R1. Therefore, the pressure chamber C communicates with the nozzle N via the communication channel R2 and communicates with the communication space Ra via the narrowed portion R1. A channel dedicated to each nozzle N is formed by the nozzle N, the communication channel R2, the pressure chamber C, and the narrowed portion R1. For convenience of description, the pressure chamber substrate 203 and the vibration plate 204 are drawn as separate substrates in FIG. 6, but are actually stacked in a single silicon substrate.

The driver element E for each pressure chamber C is formed on a surface of the vibration plate 204 opposite to the pressure chamber C. The driver element E is a piezoelectric element in a shape long along the X axis in the plan view. The driver element E includes, for example, a pair of electrodes and a piezoelectric body provided between the pair of electrodes. Instead, the driver element E may be an electrothermal transducer element to generate thermal energy.

The sealing substrate 205 is a structural body to protect the multiple driver elements E. The sealing substrate 205 is fixed to a surface of the vibration plate 204 with, for example, an adhesive. The multiple driver elements E are stored inside a dented portion formed in a surface of the sealing substrate 205 facing the vibration plate 204. Moreover, a through hole 20H into which the wiring substrate 7 to be described later is to be inserted is provided in the sealing substrate 205.

The cover 206 is a thin metallic plate forming a wall surface of the common channel Rb. The cover 206 has a thickness approximately equal to the thickness of the nozzle plate 201. The planar shape of the cover 206 is, for example, a frame shape surrounding the nozzle plate 201. A mold 207 made of a resin is provided between the cover 206 and the nozzle plate 201. The surface of the cover 206 facing in the Z1 direction constitutes a part of the nozzle surface SN.

In this chip 20, when the driver element E contracts due to energization, the vibration plate 204 is bent and deflected in the direction that reduces the volume of the pressure chamber C, and the pressure in the pressure chamber C increases, causing an ink droplet to be ejected from the nozzle N. In this process, the pressure is also transmitted toward the narrowed portion R1 from the pressure chamber C, and the ink also flows into the common channel Rb through the narrowed portion R1. After ink ejection, the driver element E returns to its original position. At this time, the ink in the region from the nozzle N to the common channel Rb also vibrates. Then, as soon as the meniscus of the nozzle N is restored, the ink is supplied from the narrowed portion R1. Through the above series of operations, the ink is ejected from the nozzle N.

Although the chip 20 in the present embodiment includes all the elements illustrated in FIG. 3, the chip 20 may include only some of the elements or may include additional elements.

The chip 20 has, for example, a monolithic structure, is a member thinner than the channel orifice forming member 25, and is, for example, a component having a thickness of smaller than 3000 μm. The chip 20 may be a component having a thickness of 1500 μm or smaller or 1000 μm or smaller. The thickness of the chip 20 may be ⅕ or smaller of the length of the short side of the chip 20 as viewed in the direction along the Z axis, which is the thickness direction of the chip 20. The chip 20 may include only at least one component among from the nozzle plate 201, the pressure chamber substrate 203, the communication plate 202 or the driver elements E, and the sealing substrate 205. The chip 20 preferably includes at least the nozzle plate 201, more preferably further includes the pressure chamber substrate 203, and particularly preferably further includes the communication plate 202. Furthermore, at least one component among from the nozzle plate 201, the pressure chamber substrate 203, the communication plate 202 or the pressure chamber substrate 203 on which the driver elements E are stacked, and the sealing substrate 205 may be regarded as the chip 20. The chip 20 may be not only a stack of silicon substrates manufactured by MEMS, but also a stack of ceramic sheets or thin plates made of metals or the like, or a stack in which thin plate-shaped members made of the aforementioned materials are stacked.

1-3Ab. Channel Orifice Forming Member 25

As illustrated in FIGS. 4 and 6, the channel orifice forming member 25 is arranged in the Z2 direction relative to the chip 20. The channel orifice forming member 25 and the chip 20 are fixed to each other with, for example, an adhesive. The channel orifice forming member 25 and the chip 20 are aligned with each other with high precision in advance. The channel orifice forming member 25 includes, for example, a channel for supplying the ink to the chip 20.

For example, the channel orifice forming member 25 is preferably a member having a thickness of 3000 μm or greater, more preferably a member having a thickness of 5000 μm or greater, and even more preferably a member having a thickness of 8000 μm or greater. The channel orifice forming member 25 may be formed of a single member or a stack of multiple members. The channel orifice forming member 25 is made of a metal herein, but may be made of a thermosetting resin. When the channel orifice forming member 25 is made of a thermosetting resin, the cost may be reduced. In the case where the channel orifice forming member 25 is made of a metal, the same metal material as in the holder 6 to be described later may be used. However, in the case where the channel orifice forming member 25 is made of a metal, the channel orifice forming member 25 is easy to reuse after the head module 2 is replaced. In addition, the channel orifice forming member 25 made of a metal can be positioned with respect to the holder 6 with higher precision than in the case where a resin is used.

As illustrated in FIG. 4, a length of the channel orifice forming member 25 in the direction along the Z axis, that is, the thickness of the channel orifice forming member 25, is greater than a thickness D2 of the chip 20. The thickness of the channel orifice forming member 25 mentioned herein is a thickness at a position coinciding with a seal area 4S to be described later, as viewed in the Z1 direction. In other words, the chip 20 is thinner than the channel orifice forming member 25. The channel orifice forming member 25 includes a surface 251 facing in the Z1 direction and a surface 252 facing in the Z2 direction.

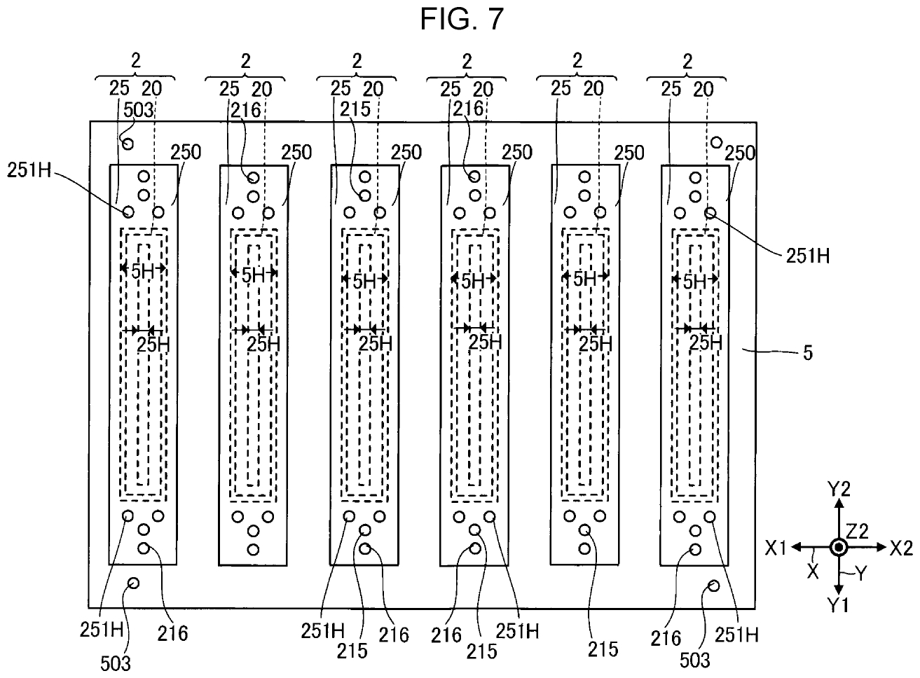

FIG. 7 is a topside view of the channel orifice forming members 25 of the head modules 2 illustrated in FIG. 4. As illustrated in FIG. 7, the planar shape of the channel orifice forming member 25 is larger than the planar shape of the chip 20. In other words, as viewed in the Z1 direction, the chip 20 is smaller in outer profile than the channel orifice forming member 25. As viewed in the Z1 direction, the channel orifice forming member 25 is arranged so as to overlap the chip 20 and cover the chip 20.

As illustrated in FIGS. 4 and 7, the channel orifice forming member 25 includes a flange portion 250 to be fixed to the cover 5 to be described later. The planar shape of the flange portion 250 is a rectangular frame shape surrounding an opening 5H of the cover 5 to be described later. As illustrated in FIG. 4, a surface of the flange portion 250 facing in the Z1 direction is a supported surface 2511 supported by the cover 5 to be described later. Since the planar shape of the flange portion 250 is the rectangular frame shape surrounding the opening 5H, the planar shape of the supported surface 2511 is similarly a rectangular frame shape surrounding the opening 5H. The supported surface 2511 is located in the Z2 direction relative to the chip 20. Accordingly, the supported surface 2511 located in the Z2 direction relative to the nozzle plate 201.

In addition, as illustrated in FIG. 7, a through hole 25H is provided to the channel orifice forming member 25. The wiring substrate 7 to be described later is to be inserted into the through hole 25H. The through hole 25H is provided at a central portion of the channel orifice forming member 25 in the plan view. In reference to FIG. 6, the through hole 25H coincides with the through hole 20H of the sealing substrate 205 in the plan view.

As illustrated in FIGS. 4 and 6, a channel 25R is formed inside the channel orifice forming member 25. The channel 25R is provided to supply the ink to the chip 20. As illustrated in FIG. 6, the space Rc is formed on the chip 20 side of the channel 25R, that is, downstream of the channel 25R. The channel 25R and the space Rc communicate with each other.

As illustrated in FIG. 4, multiple channel orifices 251H are provided on the side of the channel 25R of the channel orifice forming member 25, the side opposite to the chip 20, that is, the upstream side of the channel 25R. Each of the channel orifices 251H is a cavity end of the channel 25R in the Z2 direction. The channel orifice 251H is an orifice for a channel-forming connection between the channel 25R of the channel orifice forming member 25 of the head module 2 and a channel 6R of the holder 6 to be described later. As illustrated in FIGS. 4 and 7, the multiple channel orifices 251H are provided in the flange portion 250 of the channel orifice forming member 25. The channel orifices 251H are arranged outside the chip 20 as viewed in the Z1 direction. In the present embodiment, two channel orifices 251H are provided for each nozzle array L.

As illustrated in FIGS. 4 and 7, each channel orifice forming member 25 is provided with two fixing slots 215 and two first alignment portions 216. The head module 2 including the channel orifice forming member 25 can be detachably attached to the holder 6. The first alignment portions 216 are used for the purpose of positioning the head module 2 with respect to the holder 6 or other purposes. The fixing slots 215 are used to fix the head module 2 to the holder 6.

The first alignment portions 216 are provided on a surface 252 of the channel orifice forming member 25 facing in the Z2 direction. The surface 252 is also a surface of the head module 2 facing in the Z2 direction. In the present embodiment, the first alignment portions 216 are protrusions protruding in the Z2 direction from the surface 252 of the channel orifice forming member 25 facing in the Z2 direction. The two first alignment portions 216 are provided on both longitudinal sides of the channel orifice forming member 25 across the opening 5H of the cover 5. One of the two first alignment portions 216 is located in the Y1 direction relative to the opening 5H, whereas the other is located in the Y2 direction relative to the opening 5H.

The fixing slots 215 are provided in the surface 252 of the channel orifice forming member 25 facing in the Z2 direction. The fixing slots 215 are bottomed slots opened in the surface 252 of the channel orifice forming member 25 facing in the Z2 direction. Each fixing slot 215 is a dented portion provided in the surface 252 of the channel orifice forming member 25 facing in the Z2 direction and may be regarded as a recess formed in the surface 252. The two fixing slots 215 are provided on both longitudinal sides of the channel orifice forming member 25 across the through hole 25H, that is, both longitudinal sides thereof across the opening 5H of the cover 5. One of the two fixing slots 215 is located in the Y1 direction relative to the opening 5H, whereas the other is located in the Y2 direction relative to the opening 5H.

Each fixing slot 215 located in the Y1 direction relative to the opening 5H is closer to the opening 5H than the first alignment portion 216 located in the Y1 direction relative to the opening 5H is. Similarly, each fixing slot 215 located in the Y2 direction relative to the opening 5H is closer to the opening 5H than the first alignment portion 216 located in the Y2 direction relative to the opening 5H is. The first alignment portions 216 and the fixing slots 215 do not overlap the opening 5H as viewed in the Z1 direction. The distance from the opening 5H increases in the order of the two channel orifices 251H, the fixing slot 215, and the first alignment portion 216. Among them, the two channel orifices 251H are located closest to the opening 5H.

The minimum distance between the fixing slot 215 and the opening 5H is shorter than the minimum distance between the first alignment portion 216 and the opening 5H, but may be longer than the latter distance. Further, the first alignment portions 216, the fixing slots 215, and the opening 5H are arranged along the longitudinal direction of the cover 5, but do not have to be arranged along the longitudinal direction. For example, the first alignment portions 216 may be provided on both sides of the opening 5H along the X axis.

### 1-3B. Holder 6

As illustrated in FIGS. 3 and 4, the holder 6 holds and stores the multiple head modules 2 and includes a common channel to supply and distribute the ink to the multiple head modules 2. The holder 6 is provided in common to the multiple head modules 2.

As illustrated in FIG. 4, the holder 6 in the present embodiment includes a member in which both of one channel 6R and multiple second alignment portions 653 are formed. The channel 6R supplies the ink to each of the head modules 2 and distributes the ink to the head modules 2. The holder 6 includes a supply channel member including the channel 6R serving as the common channel. The channel 6R is the common channel provided in common to the multiple head modules 2 and includes a common portion 6RA extended along the X axis and multiple branched portions 6RB branched off from the common portion 6RA and extended in the Z1 direction. Although not illustrated, the holder 6 is provided with a channel joint for connecting to a supply channel outside the liquid ejecting head 1 so that channel 6R can communicate with the liquid reservoir section 9. This channel joint not illustrated is exposed to outside of the liquid ejecting head 1 through, for example, a not-illustrated opening formed in the holder 6.

The holder 6 may include multiple channels 6R communicating with the multiple head modules 2. Specifically, instead of the channel 6R including the common portion 6RA communicating with the multiple head modules 2, the holder 6 may include the multiple channels 6R communicating with the respective multiple head modules 2.

A head module 2 side, in other words, a downstream side of the channel 6R is provided with channel orifices 650H. Each channel orifice 650H is a cavity end of the channel 6R in the Z1 direction. The channel orifices 650H are provided corresponding to the channel orifices 251H of the head module 2. Each channel orifice 650H is an orifice for a channel-forming connection between the channel 25R of the head module 2 and the channel 6R of the holder 6.

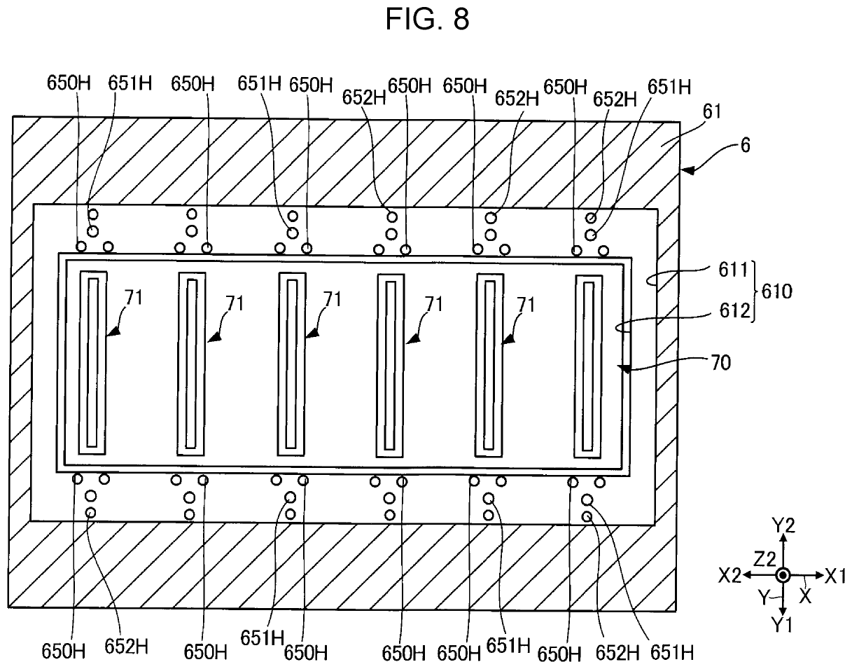

FIG. 8 is an underside view illustrating the holder 6 and the relay substrate 70 illustrated in FIG. 4. As illustrated in FIGS. 3, 4, and 8, the holder 6 has a box shape including a dented portion 610 opened in the Z1 direction. The multiple head modules 2 are arranged in a storage space inside the dented portion 610 of the holder 6. To put it differently, the holder 6 and the cover 5 form the storage space for storing the module head modules 2. The holder 6 is made of, for example, a metal such as aluminum, titanium, stainless steel, 42 alloy, or invar.

As illustrated in FIGS. 4 and 8, the dented portion 610 includes a first dented portion 611 and a second dented portion 612. As illustrated in FIG. 4, the second dented portion 612 is formed in a bottom surface of the first dented portion 611. The first dented portion 611 is located in the Z1 direction relative to the Z-axial center of the holder 6. The second dented portion 612 is located in the Z2 direction relative to the Z-axial center of the holder 6. The opening area of the second dented portion 612 is smaller than the opening area of the first dented portion 611. Accordingly, the dented portion 610 includes a step surface.

The relay substrate 70 is bonded to the bottom surface of the dented portion 610, more specifically, on the bottom surface of the second dented portion 612 with, for example, an adhesive. Although not illustrated in detail, the holder 6 is provided with an opening to which a wiring member outside the liquid ejecting head 1 for electrically connecting the relay substrate 70 to the control unit 91 is to be inserted.

As illustrated in FIG. 3, the holder 6 includes a flat plate portion 61, a sidewall 62, and two flange portions 64. The flat plate portion 61, the sidewall 62, and the two flange portions 64 are formed integrally.

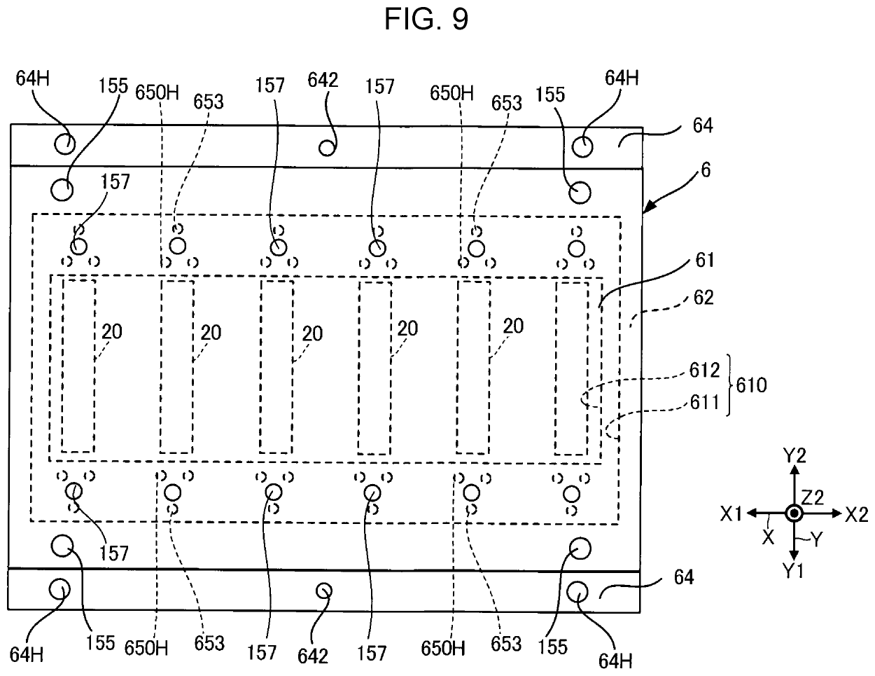

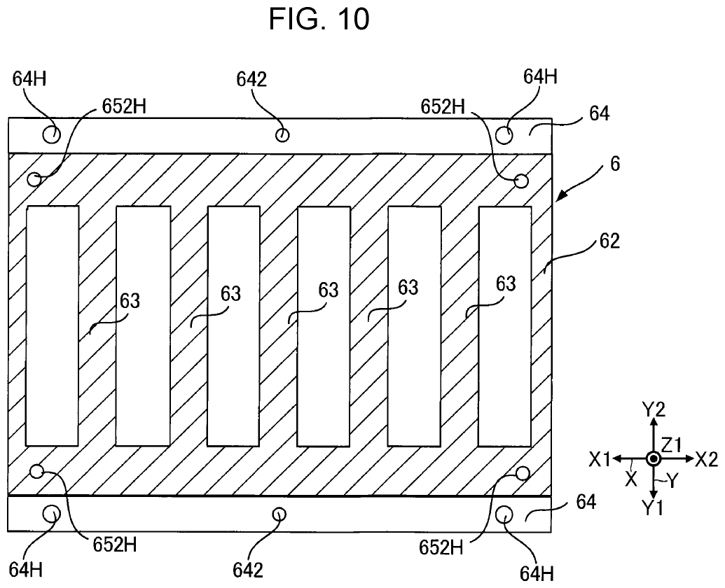

FIG. 9 is a topside view of the holder 6 illustrated in FIG. 3. FIG. 10 is a plan view of a lower portion of the holder 6 illustrated in FIG. 3. As illustrated in FIG. 3, 4, or 9, the flat plate portion 61 is a portion in a flat plate shape along an X-Y plane, and is located in the Z2 direction relative to the channel 6R. The sidewall 62 is a portion extended in the Z1 direction from an outer edge of the flat plate portion 61. A planar shape of the sidewall 62 is a rectangular frame shape. The above step surface is provided on an inner wall surface of the sidewall 62.

The first dented portion 611 is provided at a lower portion of the holder 6, and the second dented portion 612 is provided at an upper portion of the holder 6.

As illustrated in FIG. 4, the holder 6 includes multiple fixing holes 651H, multiple fixing holes 652H, and multiple second alignment portions 653. The fixing holes 651H are used to fix the head module 2 to the holder 6. The fixing holes 652H are used to fix the cover 5 to the holder 6. The second alignment portions 653 are used to position the head module 2 with respect to the holder 6.

Each fixing hole 651H is a hole passing through the holder 6 in the Z1 direction. Two fixing holes 651H are provided for each head module 2. Each fixing hole 651H is provided in the Y1 direction or the Y2 direction relative to the second dented portion 612 as viewed in the Z1 direction. The two fixing holes 651H are provided corresponding to the above-described two fixing slots 215 and coincide with the two fixing slots 215 as viewed in the Z1 direction. The fixing holes 651H do not overlap the chip 20 but overlap the channel orifice forming member 25 as viewed in the Z1 direction. A hole end of each fixing hole 651H in the Z1 direction is opened on the bottom surface of the first dented portion 611 as viewed in the Z1 direction.

Each fixing hole 652H is a hole passing through the holder 6 in the Z1 direction. As illustrated in FIG. 10, the multiple fixing holes 652H are, for example, four fixing holes 652H, and are respectively provided at four corners of the rectangular holder 6 as viewed in the Z1 direction. As illustrated in FIG. 4, the fixing holes 652H are provided corresponding to the fixing slots 503 of the cover 5. The fixing holes 652H coincide with the fixing slots 503 as viewed in the Z1 direction. None of the fixing holes 652H overlaps the dented portion 610 as viewed in the Z1 direction.

The second alignment portions 653 are provided in a surface 605 of the holder 6 facing in the Z1 direction. TWO second alignment portions 653 are provided for each head module 2. In the present embodiment, the second alignment portions 653 are bottomed slots opened in the surface 605 of the holder 6 facing in the Z1 direction, specifically, the bottom surface of the first dented portion 611. Each second alignment portion 653 is a dented portion formed in the surface 605 of the holder 6 facing in the Z1 direction, specifically, the bottom surface of the first dented portion 611. Each second alignment portion 653 is provided in the Y1 direction or the Y2 direction relative to the second dented portion 612 as viewed in the Z1 direction. The two second alignment portions 653 are provided corresponding to the above-described two first alignment portions 216 and coincide with the first alignment portions 216 as viewed in the Z1 direction. Accordingly, the multiple second alignment portions 653 are provided for the multiple first alignment portions 216 on a one-to-one basis.

In the second alignment portions 653, the first alignment portions 216 are press-fitted to position the cover 5 with respect to the holder 6. The first alignment portions 216 and the second alignment portions 653 are provided on a per-head module 2 basis.

As viewed in the Z1 direction, the fixing holes 651H are closest to the opening 5H and the fixing holes 652H are farthest from the opening 5H among the fixing holes 651H, the second alignment portions 653, and the fixing holes 652H. The distances from the opening 5H to the fixing holes 651H, the second alignment portions 653, and the fixing holes 652H may be equal to or different from each other.

The first alignment portions 216 included in the foregoing channel orifice forming member 25 are press-fitted into the foregoing second alignment portions 653 to position the head module 2 with respect to the holder 6. The first alignment portions 216 and the second alignment portions 653 are provided on the per-head module 2 basis.

The provision of the first alignment portions 216 and the second alignment portions 653 described above enables easy positioning for attaching each head module 2 to the holder 6. Moreover, since the first alignment portions 216 and the second alignment portions 653 are provided for each head module 2, it is possible to align the multiple head modules 2 with each other with high precision. For this reason, in order to replace only some of the multiple head modules 2, there is no need to realign all the head modules 2.

Moreover, the multiple head modules 2 can be aligned with each other with high precision in the simple method including press-fitting the first alignment portions 216 into the second alignment portions 653. This allows only a desired head module 2 to be replaced easily among the multiple head module 2. This makes it easy to recycle the liquid ejecting head 1.

Here, a press-fit refers to a tight fit or a transition fit. A press-fit state is defined as a state where each first alignment portion 216 is in contact with the corresponding second alignment portion 653 in at least two points, when the first alignment portion 216 is completely inserted in the second alignment portion 653. As viewed in the direction along the Z axis, before a press-fit, the length of the longest line segment connecting two points on the outer circumference of the first alignment portion 216 serving as an alignment pin is greater than the diameter of the largest circle inscribed in the second alignment portion 653 serving as an alignment slot. Moreover, in the press-fit state, the head module 2 is fitted to the holder 6 to such an extent that a force applied by the press-fit may prevent the head module 2 from falling down due to its own weight.

The channel orifices 650H and the channel orifices 251H correspond to each other as described above. Specifically, the channel orifices 650H and the channel orifices 251H coincide with each other in the direction in which the first alignment portions 216 or the second alignment portions 653 are press-fitted into the other alignment portions, namely, in the direction along the Z axis. In other words, the direction in which the channel orifices 650H and the channel orifices 251H coincide with each other is the same as the direction in which the first alignment portions 216 are press-fitted into the second alignment portions 653. For this reason, in the process of attaching the head module 2 to the holder 6, the channel-forming connections between the channel 6R and the channels 25R can be easily made with high precision.

Moreover, the multiple second alignment portions 653 are arranged in the surface 605 of the holder 6 facing in the Z1 direction, specifically, the bottom surface of the first dented portion 611. The first alignment portions 216 are arranged on the surface 252 of the channel orifice forming member 25 facing in the Z2 direction opposite to the Z1 direction.

This arrangement of the first alignment portions 216 and the second alignment portions 653 makes it possible to easily attach or detach only a head module 2 of a replacement target from below the holder 6. Therefore, in order to attach an unbroken head module 2 to the holder 6 as a replacement for a head module 2 of a replacement target, it is only necessary to make the channel-forming connections between the head module 2 as the replacement and the holder 6. Thus, there is no need to make the channel-forming connections between the head modules 2 other than the replacement target and the holder 6. Accordingly, the attachment and detachment work for repairing the liquid ejecting head 1 can be simplified.

The holder 6 is regarded as including the common channel member including one or more channels 6R communicating with the multiple head modules 2 as described above. The holder 6 including the common channel members is arranged in the Z2 direction relative to the multiple head modules 2 and overlaps the multiple head modules 2 as viewed in the Z1 direction. The first alignment portions 216 are provided on the surface 252 of the channel orifice forming member 25 facing in the Z2 direction. This structure enables easy attachment and detachment for only the head module 2 of the replacement target from below. Therefore, there is no need to disconnect the channel-forming connections between the holder 6 and the head modules 2 other than the replacement target, which simplifies the attachment and detachment work.

In addition, as described above, the first alignment portions 216 are provided on the surface of the channel orifice forming member 25 opposite to the surface provided with the chip 20, that is, the surface 252 facing in the Z2 direction. The first alignment portions 216 do not overlap the chip 20 as viewed in the Z1 direction. This arrangement of the first alignment portions 216 makes it possible to, in the process of press-fitting the first alignment portions 216 into the second alignment portions 653 of the holder 6, prevent the load due to the press-fit from acting on the chip 20.

As described above, the holder 6 includes the multiple fourth alignment portions 642. The multiple fourth alignment portions 642 are provided in the flange portions 64. As illustrated in FIG. 4, the fourth alignment portions 642 are protrusions protruding in the Z2 direction from surfaces of the flange portions 64 facing in the Z2 direction. The multiple fourth alignment portions 642 are provided corresponding to the multiple third alignment portions 102 included in the unit base 11 illustrated in FIG. 2 on a one-to-one basis.

Each of the fourth alignment portions 642 is press-fitted into one of the multiple third alignment portions 102 provided to the unit base 11, thereby positioning the liquid ejecting head 1 with respect to the unit base 11. This makes it possible to improve the precision of alignment of the multiple liquid ejecting heads 1 with the unit base 11.

In addition, as illustrated in FIG. 9, the flange portions 64 are provided with mounting slots 64H. The mounting slots 64H correspond to the mounting holes 101 of the unit base 11. Each of the mounting slots 64H is a bottomed slot opened in the surface of the flange portion 64 facing in the Z2 direction and is, for example, a screw slot for mounting the liquid ejecting head 1 to the unit base 11 with a member such as a screw. The flange portions 64 are fixed to the unit base 11 with not-illustrated members such as screws inserted into the mounting holes 101 and the mounting slots 64H in this order and then tightened. As a result, the liquid ejecting head 1 is fixed to the unit base 11.

### 1-3C. Seal Member 4

As illustrated in FIGS. 3 and 4, the seal members 4 are provided between the head modules 2 and the holder 6 in the Z1 direction. The seal members 4 are provided for each head module 2. The seal members 4 are elastic. The seal members 4 are made of an elastic material such as elastomer, for example. In the present embodiment, the length of the seal member 4 along the Z axis, that is, the thickness of the seal member 4, is constant. The thickness of the seal member 4 is smaller than the thicknesses of the channel orifice forming member 25 and the holder 6. The seal member 4 is squeezed between the head module 2 and the holder 6.

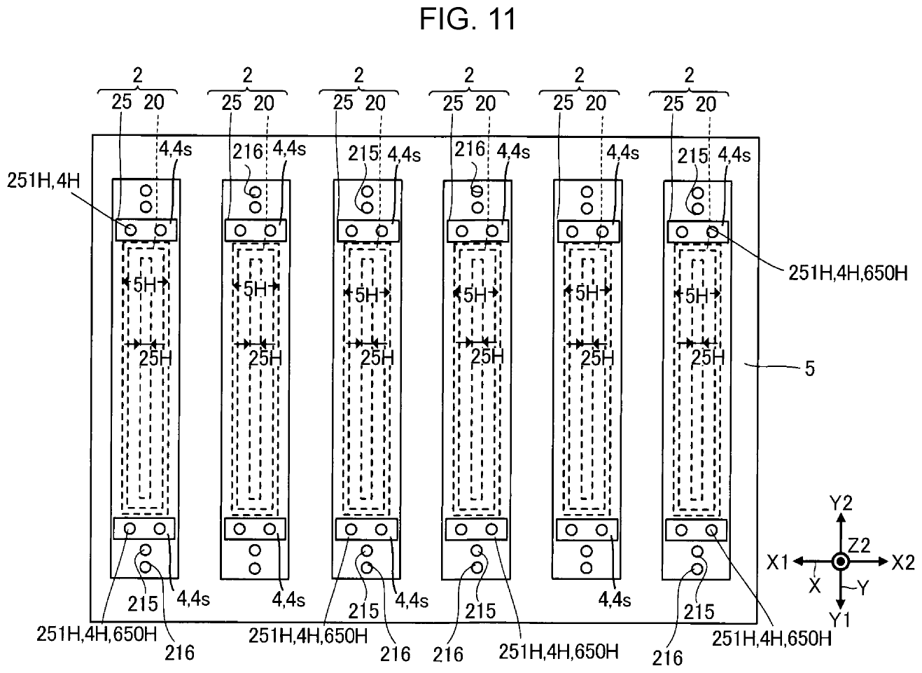

FIG. 11 is a topside view of the seal members 4 illustrated in FIG. 4. In the example illustrated in FIG. 11, two seal members 4 are provided for each head module 2. The two seal members 4 are provided at both longitudinal ends of one head module 2. Each seal member 4 has a rectangular shape as viewed in the Z1 direction. Each seal member 4 overlaps the flange portion 250 included in the channel orifice forming member 25 of the head module 2 as viewed in the Z1 direction. On the other hand, in the present embodiment, the seal members 4 are provided at positions different from the chips 20 as viewed in the Z1 direction. In other words, the seal members 4 do not overlap the chips 20 as viewed in the Z1 direction.

As illustrated in FIGS. 4 and 11, each seal member 4 includes two communication orifices 4H. As illustrated in FIG. 4, each communication orifice 4H is provided corresponding to one of the channel orifices 251H of the channel orifice forming members 25 and one of the channel orifices 650H of the holder 6. As illustrated in FIG. 11, the communication orifice 4H coincides with both the channel orifice 650H and the channel orifice 251H as viewed in the Z1 direction. As illustrated in FIG. 4, the communication orifice 4H is connected to the channel 25R via the channel orifice 251H. The communication orifice 4H is connected to the channel 6R via the channel orifice 650H. Thus, the channel 25R and the channel 6R communicate with each other through the communication orifice 4H. Specifically, the channel 25R and the channel 6R communicate with each other through the communication orifice 4H with the seal member 4 squeezed between the channel orifice forming member 25 and the holder 6.

Such a seal member 4 is a member for liquid-tightly connecting the channel orifices 251H of the head module 2 and the channel orifices 650H of the holder 6. The ink flowing in the channel 6R of the holder 6 flows into the channels 25R of the channel orifice forming members 25 via the communication orifices 4H and is supplied to the dedicated channels included in the chips 20 via the common spaces R.

As illustrated in FIG. 11, the seal member 4 has a seal area 4S. In the present embodiment, the entire area of the seal member 4 serves as the seal area 4S. The seal area 4S is an area of the seal member 4 that is in contact with both the channel orifice forming member 25 and the holder 6 and held between the channel orifice forming member 25 and the holder 6. The seal area 4S is an area squeezed with application of a load from the channel orifice forming member 25 and the holder 6 so as to liquid-tightly connect the channel orifices 251H and the channel orifices 650H. In other words, even an area of the seal member 4 located between the channel orifice forming member 25 and the holder 6 is not included in the seal area 4S if the area is not squeezed with application of the load from both members, and does not actually contribute to the liquid-tight connection between the channel orifice 251H and the channel orifice 610H.

As illustrated in FIG. 11, the seal members 4 are provided at the positions different from the chips 20 as viewed in the Z1 direction, and accordingly the seal areas 4S are provided at the positions different the chips 20 as viewed in the Z1 direction. In other words, the seal areas 4S do not overlap the chip 20 as viewed in the Z1 direction. Since the seal areas 4S do not overlap the chips 20 as viewed in the Z1 direction, the reaction force of the seal members 4 is less likely to act on the chips 20 than if they overlap the chips 20. As a result, the reliability of the head modules 2 can be improved.

As described above, the channel 25R and the channel 6R communicate with each other through the communication orifices 4H with the seal member 4 squeezed between the channel orifice forming member 25 and the holder 6. The reaction force of the squeezed seal member 4 may apply stress to the chip 20, and cause warping or the like of the chip 20. In this way, if the reaction force of the seal member 4 acts on the chip 20, the reliability of the head module 2 may deteriorate due to the occurrence of an undesirable phenomenon such, for example, as displacement of the nozzles N as a result of deformation of the nozzle plate 201, a change in ejection characteristics as a result of deformation of the pressure chamber substrate 203 and the communication plate 202, or a breakage of any of members constituting the chip 20 if the members include a silicon substrate or ceramic sheet.

In the present embodiment, the seal areas 4S of the seal members 4 do not overlap the chips 20 as viewed in the Z1 direction. For this reason, it is possible to keep the reaction force of the seal members 4 from acting on the chips 20 while keeping the sealing performance of the seal members 4 from decreasing. Thus, the reliability of the head modules 2 can be improved.

Further, the seal members 4 corresponding to the multiple head modules 2 included in the liquid ejecting head 1 do not overlap the chips 20 as viewed in the Z1 direction. As a result, in the multiple head modules 2, it is possible to keep the reaction force of the seal members 4 from acting on the chips 20 while keeping the sealing performance of the seal members 4 from decreasing. Thus, the reliability of the liquid ejecting head 1 can be improved.

As illustrated in FIG. 11, none of the communication orifices 4H, the channel orifices 251H, and the channel orifices 650H overlaps the chips 20 as viewed in the Z1 direction. All of the communication orifices 4H, the channel orifices 251H, and the channel orifices 650H are arranged outside the chips 20 as viewed in the Z1 direction. Specifically, the communication orifices 4H and the channel orifices 251H and 650H are arranged on both longitudinal sides of each chip 20 as viewed in the Z1 direction. For this reason, the seal areas 4S of the seal members 4 which liquid-tightly seal the channels 25R and 6R as described above can be arranged outside the chips 20. Accordingly, as described above, the reaction force of the seal members 4 can be kept from affecting the chips 20.

In addition, each of the seal areas 4S is arranged in the Y1 direction or the Y2 direction, which is a longitudinal direction of the head module 2, relative to the chip 20 as viewed in the Z1 direction. Since the seal areas 4S are arranged in the longitudinal directions relative to the chips 20, none of the seal areas 4S is arranged between the adjacent chips 20. This can avoid an increase in the distance between the adjacent chips 20 due to the seal area 4S if provided. For this reason, the print quality is less likely to be affected.

However, the seal areas 4S may be arranged, relative to the chips 20, in directions in which the multiple head modules 2 are arrayed, that is, the short side directions of the head modules 2. The seal members 4 may be provided, relative to the chips 20, in the directions in which the multiple head modules 2 are arrayed, that is, the short-side directions of the head modules 2.

### 1-3D. Cover 5

The cover 5 illustrated in FIGS. 3 and 4 is a support member that supports the multiple head modules 2. The cover 5 is provided in common to the multiple head modules 2 but may be individually provided for the respective multiple head modules 2. The cover 5 is a plate-shaped member that is long along the Y axis while a thickness direction thereof is a direction along the Z axis. The cover 5 is arranged in the Z1 direction relative to the channel orifice forming member 25. The cover 5 is a member that sandwiches the seal members 4 and the channel orifice forming member 25 between itself and the holder 6. As illustrated in FIG. 4, the cover 5 includes a surface 511 facing in the Z1 direction and a surface 512 facing in the Z2 direction. The cover 5 is a member that does not include any channel through which the ink flows.

The cover 5 is fixed to the holder 6 to be described later in a detachably-attached manner. Specifically, the cover 5 is not bonded to with an adhesive or the like. The cover 5 can be detachably attached to the holder 6. For this reason, the cover 5 can be detached from the holder 6. The cover 5 may be regarded as a sub-holder of the holder 6.

In the present embodiment, the cover 5 holds each of the head modules 2 in a detachably attached manner. Therefore, each head module 2 can be detached from the cover 5.

Here, it is preferable to fix the head modules 2 to the cover 5 with an adhesive, and each head module 2 may be configured to be detachable from the cover 5 with decomposition of the adhesive.

The cover 5 is made of, for example, a metal. The cover 5 is made of a metal such, for example, as aluminum or stainless steel. The cover 5 has stiffness sufficient to support the multiple head modules 2.

As illustrated in FIGS. 4 and 5, the cover 5 is provided with multiple openings 5H. Each opening 5H is a hole passing through the cover 5 in the thickness direction. Each opening 5H is provided for exposing a part of the corresponding head module 2 to outside. Specifically, the chip 20 is exposed from the opening 5H. Accordingly, the multiple nozzles N are exposed from the opening 5H.

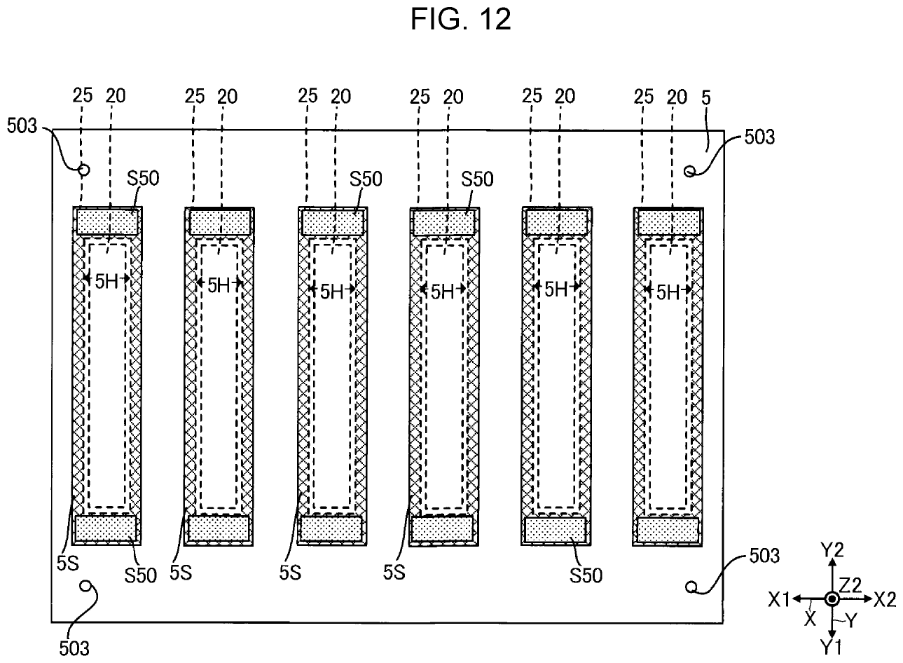

FIG. 12 is a topside view of the cover 5 illustrated in FIG. 4. As illustrated in FIGS. 4 and 12, the cover 5 includes multiple support areas 5S. Each support area 5S is a part of the surface 512 of the cover 5 facing in the Z2 direction. In FIG. 12, the support areas 5S are hatched for facilitating understanding. In the example of FIG. 12, each support area 5S has a rectangular frame shape as viewed in the Z1 direction.

As illustrated in FIG. 4, the support area 5S is an area that is in contact with the channel orifice forming member 25 and directly supports the channel orifice forming member 25. The support area 5S is in contact with the supported surface 2511 of the channel orifice forming member 25. The support area 5S includes areas S50 coinciding with the seal areas 4S as viewed in the Z1 direction. In FIG. 12, the areas S50 are dotted.

Since the support area 5S includes the areas S50 coinciding with the seal areas 4S as viewed in the Z1 direction, the cover 5 vertically receives the reaction force of the seal members 4. Therefore, the cover 5 can firmly support the seal areas 4S of the seal members 4 between itself and the holder 6. Accordingly, the cover 5 can particularly effectively alleviate the reaction force of the seal members 4.

Moreover, a part of the above-described surface 251 of the channel orifice forming member 25 facing in the Z1 direction includes the supported surface 2511. The supported surface 2511 is supported by being in contact with the cover 5 while surrounding the opening 5H of the cover 5 as viewed in the Z1 direction. Specifically, the head module 2 is held by the cover 5 with the supported surface 2511 put in contact with the support area 5S of the cover 5. When the channel orifice forming member 25 is supported by the cover 5 as described above, the load of the seal members 4 can be distributed. As a result, the channel orifice forming member 25 can be made less likely to be broken.

Here, the contact between the supported surface 2511 and the support area 5S means not only a direct contact between them and but also a connection between them via an adhesive, an elastic bushing, or the like. Accordingly, the channel orifice forming member 25 may be in direct contact with the cover 5 or may be in indirect contact with the cover 5 via another member such as an adhesive or a bushing. The flange portion 250 may have a shape other than the rectangular frame shape in the plan view. For example, the flange portions 250 in rectangular shapes may be provided in both of the Y1 and Y2 directions relative to the opening 5H in the plan view.

The thickness of the flange portion 250, that is, the length along the Z1 direction, is preferably greater than the thickness of the part of the channel orifice forming member 25 arranged inside the opening 5H. In addition, the thickness of the flange portion 250 is preferably ½ or greater of the maximum thickness of the channel orifice forming member 25. Such a thickness relationship keeps the strength of the flange portion 250 from decreasing, and makes it easier for the flange portion 250 to ensure the strength in receiving the reaction force of the seal members 4.

Moreover, the thickness D5 of the cover 5 in the Z1 direction is greater than the thickness D2 of the chip 20 in the Z1 direction, the thickness D5 is greater than the thickness D2. This can reduce a risk of the cover 5 being deformed due to the reaction force of the seal members 4.

The thickness D5 of the cover 5 is preferably two or more times and more preferably three or more times greater than the thickness D2 of the chip 20. This can further reduce the risk of the cover 5 being deformed due to the reaction force of the seal members 4. However, the thickness D5 may be equal to or smaller than the thickness D2.

From the same viewpoint, the thickness D5 of the cover 5 is preferably 1 mm or greater and more preferably 2 mm or greater. In order to further enhance the strength of the cover 5, the thickness D5 may be 3 mm or greater, 5 mm or greater, or 6 mm or greater. On the other hand, from the viewpoint of an increase in the distance between the medium 90 and the nozzle surface SN, that is, a paper gap, the thickness D5 of the cover 5 is preferably 10 mm or smaller, and more preferably 7 mm or smaller.

As illustrated in FIG. 4, in addition to the chip 20, the part of the channel orifice forming member 25 is arranged in the opening 5H of the cover 5. In other words, the part of the channel orifice forming member 25 is inserted in the opening 5H of the cover 5. In the case where the cover 5 exists, the paper gap may increase depending on how great the thickness D5 of the cover 5 is. Specifically, if the thickness D5 of the cover 5 is excessively great, the surface of the chip 20 facing in the Z1 direction may be retracted in the Z2 direction from the surface of the cover 5 facing in the Z1 direction. An increase in the above distance may result in a decrease in the accuracy of ink impact positions on the medium 90.

In the present embodiment, as described above, in addition to the chip 20, the part of the channel orifice forming member 25 is arranged in the opening 5H. Thus, even if the thickness D5 of the cover 5 is increased in order to further enhance the strength of the cover 5, the paper gap may be prevented from increasing.

Further, the surface of the nozzle plate 201 facing in the Z1 direction, namely, the nozzle surface SN, in the chip 20 is approximately flush with the surface 511 of the cover 5 facing in the Z1 direction. In other words, the nozzle surface SN and the surface 511 of the cover 5 facing in the Z1 direction are located at the same Z-axial position. In this case, the paper gap can be kept from increasing as compared with the case where the nozzle surface SN is retracted in the Z2 direction from the surface 511 of the cover 5 facing in the Z1 direction. Moreover, it is easy to collectively wipe the surface 511 of the cover 5 facing in the Z1 direction and the nozzle surface SN.

The nozzle surface SN and the surface 511 of the cover 5 facing in the Z1 direction being approximately flush with each other means not only a case where they are completely flush with each other, but also a case where they have a step formed in between to the extent including a manufacturing error or the like.

Instead, the nozzle surface SN and the surface 511 of the cover 5 facing in the Z1 direction do not have to be approximately flush with each other. The nozzle surface SN and the surface 511 of the cover 5 facing in the Z1 direction may be located at different Z-axial positions or may have a step formed in between. In this case, from the viewpoint of ease of wiping, the distance between the nozzle surface SN and the surface 511 of the cover 5 facing in the Z1 direction is preferably 100 μm or smaller and more preferably 50 μm or smaller.

As illustrated in FIG. 4, the cover 5 includes multiple fixing slots 503. The fixing slots 503 are used to fix the cover 5 to the holder 6. As illustrated in FIG. 4, the fixing slots 503 are provided in the surface 512 of the cover 5 facing in the Z2 direction. Each fixing slot 503 is a bottomed slot provided in the surface 512 of the cover 5 facing in the Z2 direction. Each fixing slot 503 is a dented portion provided in the surface 512 of the cover 5 facing in the Z2 direction and may be regarded as a recess formed in the surface 512. The multiple fixing slots 503 correspond to the foregoing multiple fixing holes 652H on a one-to-one basis, and coincide with the fixing holes 652H as viewed in the Z1 direction.

The cover 5 is fixed in contact with an outer peripheral wall of the dented portion 610, specifically, the surface 605 of the holder 6 facing in the Z1 direction. Specifically, the holder 6 and the cover 5 are fixed to each other with fixing members 157 to be described later inserted into the fixing holes 652H and the fixing slots 503. Then, the cover 5 includes the multiple openings 5H for exposing the respective multiple head modules 2 to the outside as described above.

When the cover 5 is thus provided, the cover 5 allows the nozzle surfaces SN serving as the ink ejection surfaces to be exposed and prevents ink mist from entering the inside of the dented portion 610 of the holder 6.

Although one cover 5 is provided for one holder 6, multiple covers 5 may be provided. For example, a cover 5 that holds three head modules 2 among the six head modules 2 and a cover 5 that holds the remaining three head modules 2 may be provided.

For example, two or more head modules 2 to be replaced at similar timings are held by one cover 5. Thus, the two or more head modules 2 to be replaced at the similar timings may be collectively replaced, which facilitates the replacement work.

Specifically, for example, the cover 5 preferably holds multiple head modules 2 to eject the same type of liquid among the multiple head modules 2. This makes it possible to collectively replace head modules 2 having similar life spans, such as head modules 2 for a color whose ejection frequency is high. As a result, the workability for replacement is improved. However, the two or more head modules 2 held by one cover 5 may eject different types of inks. One head module 2 may be capable of ejecting one type of ink or two or more types of inks.

### 1-3E. Fixing Member Group 150

As illustrated in FIG. 4, a fixing member group 150 includes multiple fixing members 155 and multiple fixing members 157.

The fixing members 155 fix the cover 5 to the holder 6. Each fixing member 155 is inserted into the fixing hole 652H as the through hole and the fixing slot 503 as the dented portion in this order. For this reason, the fixing member 155 is not exposed to the nozzle surface SN side. Meanwhile, a part of the fixing member 155 is exposed from the surface 606 of the holder 6 facing in the Z2 direction.

For example, after the fixing members 155 are removed from the fixing holes 652H, long rod-shaped members are inserted into the fixing holes 652H and the cover 5 is pressed in the Z1 direction by these members. In this way, the press-fit of the cover 5 in the holder 6 can be released easily. More specifically, the press-fit of the cover 5 in the holder 6 can be easily released by using the fixing holes 652H as holes for releasing the press-fit.

The fixing members 157 directly fix the head module 2 to the holder 6. Each fixing member 157 is inserted into the fixing hole 651H as the through hole and the fixing slot 215 as the dented portion in this order. For this reason, the fixing member 157 is not exposed to the surface of the liquid ejecting head 1 facing in the Z1 direction, specifically, the nozzle surface SN side. Meanwhile, a part of the fixing member 157 is exposed from the surface 606 of the holder 6 facing in the Z2 direction. Since the fixing members 157 are not exposed on the nozzle surface SN side, the fixed members 157 are protected from adhesion and solidification of ink mist. This makes it possible to prevent the fixing members 157 from becoming difficult to remove from the holder 6 and the head module 2 due to the adhesion of the mist.

For example, after the fixing members 157 are removed from the fixing holes 651H, long rod-shaped members are inserted into the fixing holes 651H, and the head module 2 is pressed in the Z1 direction by these members. In this way, the press-fit of the head module 2 in the holder 6 can be released easily. More specifically, the press-fit of the head module 2 in the holder 6 can be easily released by using the fixing holes 651H as holes for releasing the press-fit.

The fixing member 157 is equivalent to a “first fixing member”. The fixing hole 651H is equivalent to a “first fixing hole”. The fixing slot 215 is equivalent to a “first fixing slot”.

A depth D66 of the fixing hole 651H is greater than a depth D26 of the fixing slot 215. In the case where the depth D66 is greater than the depth D26, the channel orifice forming member 25 is detached from the holder 6 more easily than in the case where the depth D66 is smaller than the depth D26.

As illustrated in FIG. 9, for example, the multiple fixing members 155 are provided near the corners of the rectangular holder 6 as viewed in the Z1 direction. The multiple fixing members 157 are provided on the per-head module 2 basis. Specifically, two fixing members 157 are provided for each head module 2. One of the two fixing members 157 is located in the Y1 direction relative to the head module 2, whereas the other is located in the Y2 direction relative to the head module 2 as viewed in the Z1 direction.

Both the fixing members 155 and 157 are preferably screws. Accordingly, for example, female threads are formed on inner circumferential wall surfaces forming the fixing holes 651H, the fixing holes 652H, the fixing slots 215, and the fixing slots 503. When the fixing members 155 and 157 are the screws, the fixing of the cover 5 and the multiple head modules 2 to the holder 6 can be easily released by rotating and unscrewing the screws. When the fixing members 155 and 157 are the screws, the multiple head modules 2 and the cover 5 can be attached to and detached from the holder 6 as needed without using an adhesive.

The fixing members 155 and 157 may be members other than the screws, and may each include, for example, an L-shaped or T-shaped pin with its tip end in the Z1 direction bent at a right angle and an elastic member such as a leaf spring or coil spring, and be configured to fix the cover 5 to the holder 6 by using the elastic force of the elastic member.

As described above, the fixing member 155 may have any structure as long as the fixing member 155 can fix the holder 6 and the cover 5 to each other. The fixing member 157 may have any structure as long as the fixing member 157 can fix the holder 6 and the head module 2 to each other.

As viewed in the Z1 direction, the fixing members 155 and 157 are arranged so as not to overlap the chip 20 and so as to sandwich the seal member 4 between the chip 20 and the fixing members 155 and 157.

In the case where the fixing members 155 and 157 do not overlap the chip 20 as viewed in the Z1 direction, the load generated for fixing with the fixing members 155 and 157 is less likely to be applied to the chip 20 than in the case where the fixing members 155 and 157 overlap the chip 20. Moreover, as viewed in the Z1 direction, the seal member 4 is arranged between the fixing members 155 and 157 and the chip 20, so that the distances of the chip 20 from the fixing members 155 and 157 can be made longer by the dimension of the seal member 4. This also makes the load generated for fixing with the fixing members 155 and 157 unlikely to be applied to the chip 20.

### 1-3F. Wiring Substrate 7, Relay Substrate 70, and Connector

As illustrated in FIG. 3, the wiring substrate 7 is provided for each head module 2. The wiring substrate 7 is inserted into the through hole 20H of the chip 20 and the through hole 25H of the channel orifice forming member 25. The wiring substrate 7 is joined to the vibration plate 204. The wiring substrate 7 protrudes from the vibration plate 204 in the Z2 direction. The wiring substrate 7 is a mounting component in which multiple wiring lines for electrically connecting the chip 20 and the relay substrate 70 are formed. The wiring substrate 7 is, for example, a flexible substrate such as a flexible printed circuit (FPC) or a chip on film (COF), or a rigid substrate. From the wiring substrate 7, each driver element E is supplied with a driving signal and a reference voltage for driving the driver element E.

The relay substrate 70 is fixed to the bottom surface of the dented portion 610 in the surface 605 of the flat plate portion 61 of the holder 6 facing in the Z1 direction. The relay substrate 70 has a flat plate shape, and is fixed to the holder 6 with an adhesive or the like. The relay substrate 70 is electrically connected to the control unit 91. Multiple connectors 71 are equipped in the relay substrate 70. The multiple connectors 71 are provided for the multiple wiring substrates 7 on a one-to-one basis. An end portion of the wiring substrate 7 provided with multiple terminals is inserted into each connector 71 in a removably-inserted manner. In other words, it is preferable that wiring substrate 7 be formed of a rigid body in order to facilitate insertion and removal of the end portion of the wiring substrate 7 into and from the connector 71. In the case where the wiring substrate 7 is formed of a flexible substrate, it is desirable to bond a rigid body to the flexible substrate to support the flexible substrate. When the end portion of the wiring substrate 7 is inserted into the connector 71, the wiring substrate 7 is electrically connected to the control unit 91 via the relay substrate 70.

The relay substrate 70 is electrically connected to the multiple head modules 2. The relay substrate 70 is arranged in the Z2 direction, which is opposite to the Z1 direction, relative to the multiple head modules 2, and overlaps the multiple head modules 2 as viewed in the Z1 direction. The first alignment portions 216 are provided on the surface of the cover 5 facing in the Z2 direction. This arrangement enables easy attachment and detachment for only the head module 2 of the replacement target from below the holder 6 and the relay substrate 70. Therefore, there is no need to disconnect the electric connections of the head modules 2 other than the replacement target, which simplifies the attachment and detachment work.

Moreover, as described above, the wiring substrate 7 is arranged on the bottom surface of the dented portion 610 of the holder 6. In this case, a length of the head module 2 and the wiring substrate 7 can be more easily reduced than in the case where the wiring substrate 7 is arranged on the surface 606 of the holder 6 facing in the Z2 direction.

In the process of attaching only the head module 2 as a replacement to the holder 6 from below the holder 6 as described above, the wiring substrate 7 is moved in the Z2 direction from below the connector 71 to the connector 71. Then, the wiring substrate 7 is inserted into the connector 71. As a result, the wiring substrate 7 is electrically connected to the relay substrate 70.

### 1-3G. Bushing

As illustrated in FIG. 4, bushings 526 are provided between the channel orifice forming member 25 and the cover 5. Although not illustrated in detail, for example, the bushings 526 are provided in the Y1 direction and the Y2 direction relative to each channel orifice forming member 25 as viewed in the Z1 direction. In addition, a bushing 522 is provided between the holder 6 and the cover 5. Although not illustrated in detail, the busing 522 is arranged in a rectangular frame shape along the outer edge of the holder 6 as viewed in the Z1 direction. The bushings 526 and 522 are each made of an elastic resin material. The provision of the bushings 526 and 522 makes it possible to reduce a risk of ink mist or the like entering the storage space inside the dented portion 610 of the holder 6 from the outside of the liquid ejecting head 1.

### 2. Modifications

The first embodiment described above as the example may be modified in various manners. Examples of specific modifications applicable to the above-described first embodiment will be described below. Any two or more modifications selected from the following examples may be combined as appropriate unless they are mutually inconsistent.

### 2-1. First Modification

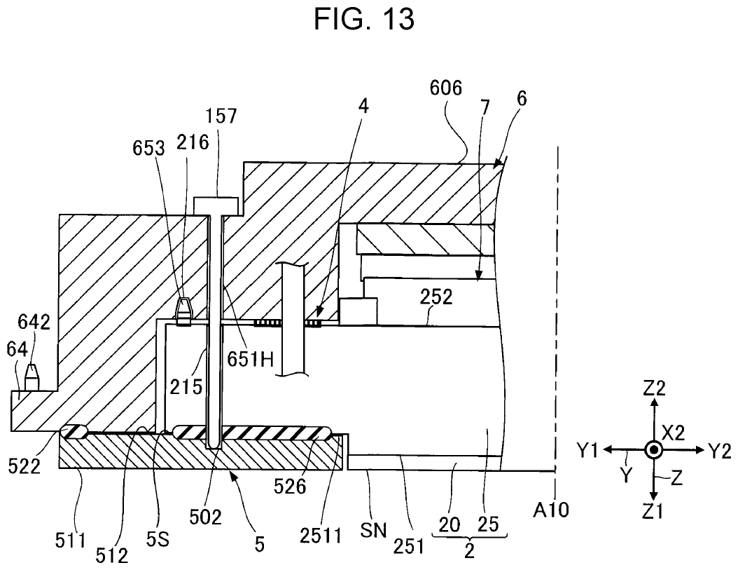

FIG. 13 is a cross-sectional view of a part of a liquid ejecting head 1 in a first modification. The fixing member 157 in the first modification illustrated in FIG. 13 fixes the cover 5 in addition to the holder 6 and the head module 2. In the first modification, the fixing members 155 are omitted. According to the first modification, the number of fixing members can be reduced as compared with the first embodiment. Thus, according to the first modification, the head module 2 can be attached to and detached from the holder 6 by using a smaller number of fixing members than in the first embodiment. In addition, in the first modification, since an adhesive is not used to fix the head module 2 to the cover 5, the head module 2 is easily attached to and detached from the cover 5.

### 2-2. Second Modification

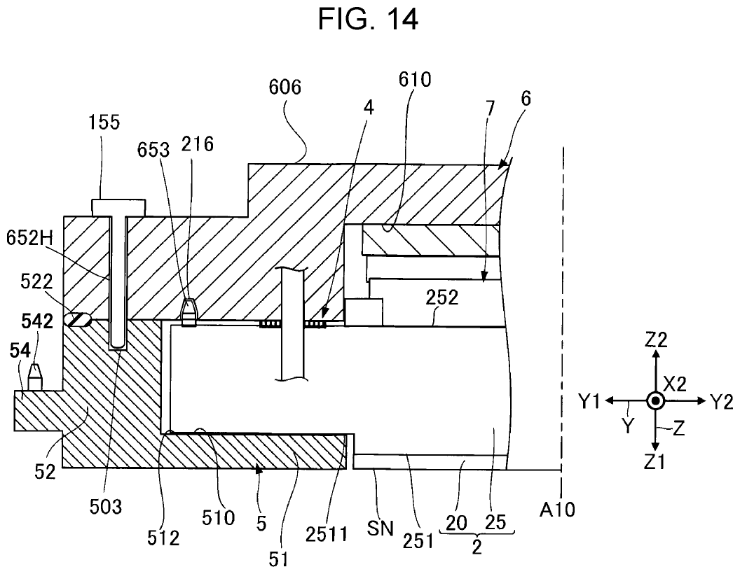

FIG. 14 is a cross-sectional view of a part of a liquid ejecting head 1 in a second modification. In the second modification illustrated in FIG. 14, the holder 6 does not include the second dented portion 612. In other words, the dented portion 610 of the holder 6 in the second modification does not have the step surface. The dented portion 610 is a storage space for storing the relay substrate 70.

The cover 5 in the second modification includes a bottom plate portion 51 and a sidewall 52. The bottom plate portion 51 has a plate shape and has the same structure as the cover 5 in the first embodiment. The sidewall 52 is a frame-shaped portion protruding from an outer edge of the bottom plate portion 51 in the Z2 direction. The cover 5 has a dented portion 510. An inside of the dented portion 510 forms a storage space for storing the multiple head modules 2.

The shapes of the holder 6 and the cover 5 are not particularly limited as described above, but may be any shapes as appropriate. One or both of the holder 6 and the cover 5 form the space for storing the head modules 2.

In addition, the cover 5 in the second embodiment includes flange portions 54. The flange portions 54 are the same as the flange portions 64 included in the holder 6 in the first embodiment. However, the flange portions 54 are provided not to the holder 6 but to the cover 5. Each of the flange portions 54 includes a fourth alignment portion 542. The fourth alignment portion 542 has the same structure as the fourth alignment portion 642 in the first embodiment, and is press-fitted into the third alignment portion 102 of the unit base 11.

For example, each head module 2 is fixed to the cover 5 with an adhesive or the like. The head module 2 can be detached from the holder 6 by removing the fixing members 155. In the case where the head module 2 is fixed to the cover 5 with the adhesive, it can be considered that the head module 2 is fixed to the cover 5 in the detachably-attached manner if, for example, the head module 2 can be separated from the cover 5 by melting the adhesive with heat.

### 2-3. Third Modification

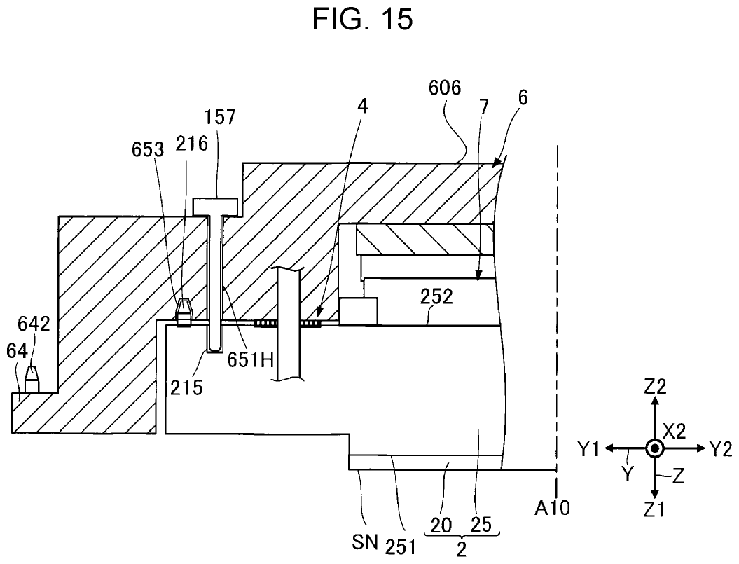

FIG. 15 is a cross-sectional view of a part of a liquid ejecting head 1 in a third modification. In the third modification illustrated in FIG. 15, the cover 5 is omitted. According to the third modification, the number of components can be reduced as compared with the first embodiment. Since the cover 5 is omitted, the head module 2 can be attached to and detached from the holder 6 more easily than in the first embodiment.

### 2-4. Fourth Modification

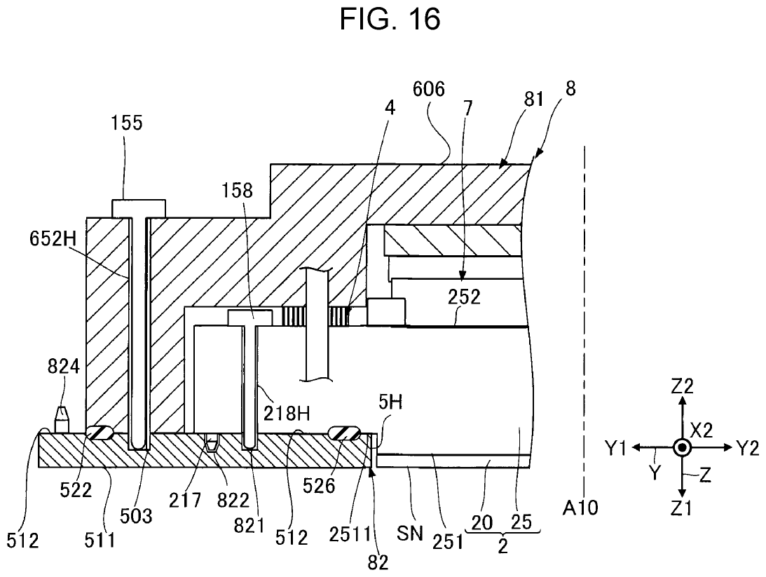

FIG. 16 is a cross-sectional view of a part of a liquid ejecting head 1 in a fourth modification. The liquid ejecting head 1 in the fourth modification illustrated in FIG. 16 includes a holder 8. The holder 8 includes a first holder 81 and a second holder 82. The first holder 81 is the same as the holder 6 in the first embodiment except that the flange portions 64 are omitted.

The second holder 82 is the same as the cover 5 in the first embodiment except for the following elements. As viewed in the Z1 direction, the second holder 82 includes a portion extended more in the Y1 direction or the Y2 direction than the first holder 81. The extended portion is provided with a fourth alignment portion 824. The fourth alignment portion 824 has the same structure as the fourth alignment portion 642 in the first embodiment, and is press-fitted into the third alignment portion 102 of the unit base 11.

The second holder 82 also includes multiple fixing slots 821 and multiple second alignment portions 822. Two fixing slots 821 are provided for each head module 2. One of the two fixing slots 821 is located in the Y1 direction relative the chip 20, whereas the other is located in the Y2 direction relative to the chip 20 as viewed in the Z1 direction. Each fixing slot 821 is a slot opened in a surface 512 of the second holder 82 facing in the Z2 direction. The fixing slot 821 may be referred to as a dented portion formed in the surface 512 of the second holder 82 facing in the Z2 direction. The head module 2 includes fixing holes 218H corresponding to the fixing slots 821. Each fixing hole 218H is a hole passing through the channel orifice forming member 25 of the head module 2.

Two second alignment portions 822 are provided for each head module 2. Although not illustrated in detail, one of the two second alignment portions 822 is located in the Y1 direction relative to the chip 20, whereas the other is located in the Y2 direction relative to the chip 20 as viewed in the Z1 direction. Each second alignment portion 822 is a slot opened in the surface 512 of the second holder 82 facing in the Z2 direction. The second alignment portion 822 is a dented portion formed in the surface 512 of the second holder 82 facing in the Z2 direction and may be regarded as a recess formed in the surface 512.

In addition, the head module 2 includes first alignment portions 217 corresponding to the second alignment portions 822. The first alignment portions 217 are protrusions protruding in the Z1 direction from the surface 251 of the channel orifice forming member 25 facing in the Z1 direction. The first alignment portions 217 are press-fitted into the second alignment portions 822. Thus, the head module 2 is positioned with respect to the holder 8 including the second holder 82.

A fixing member 158 is inserted into the fixing hole 218H and the fixing slot 821 in this order. The fixing member 158 is equivalent to a “first fixing member”. The fixing member 158 is, for example, a screw, and female threads are formed on inner wall surfaces forming the fixing hole 218H and the fixing slot 821. The head module 2 is fixed to the second holder 82 with the fixing members 158 inserted and screwed in the fixing holes 218H and the fixing slots 821. The first holder 81 and the second holder 82 are fixed to each other with the fixing members 155 as in the case of the cover 5 and the holder 6 in the first embodiment.

The second holder 82 of the holder 8 includes multiple openings 5H as in the cover 5. From the multiple openings 5H, the respective multiple head modules 2 are exposed to the outside. Then, a part of the channel orifice forming member 25 is inserted into each of the openings 5H. For this reason, with the second holder 82 including the multiple openings 5H, an increase in the paper gap can be suppressed as in the case of the cover 5 in the first embodiment. In addition, there is no need to reduce the thickness of the second holder 82 in order to suppress the increase in the paper gap. Accordingly, the stiffness of the second holder 82 can be kept from decreasing.

### 2-5. Fifth Modification

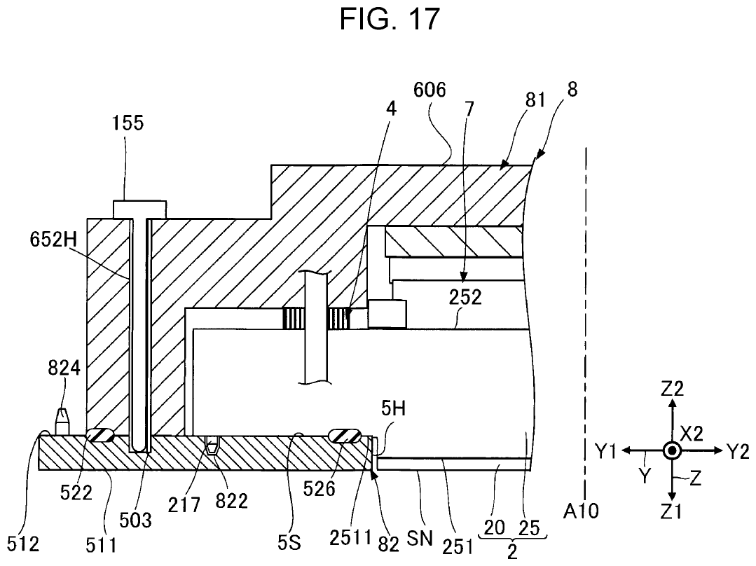

FIG. 17 is a cross-sectional view of a part of a liquid ejecting head 1 in a fifth modification. In the fifth modification illustrated in FIG. 17, the fixing holes 218H, the fixing slots 821, and the fixing members 158 are omitted as compared with the fourth modification. In the fifth modification, each head module 2 is fixed to the second holder 82 with an adhesive or the like. In the case where the head module 2 is fixed to the second holder 82 with the adhesive, it can be considered that the head module 2 is fixed to the second holder 82 in the detachably-attached manner if the head module 2 can be separated from the second holder 82 by, for example, melting the adhesive with heat.

### 2-7. Seventh Modification

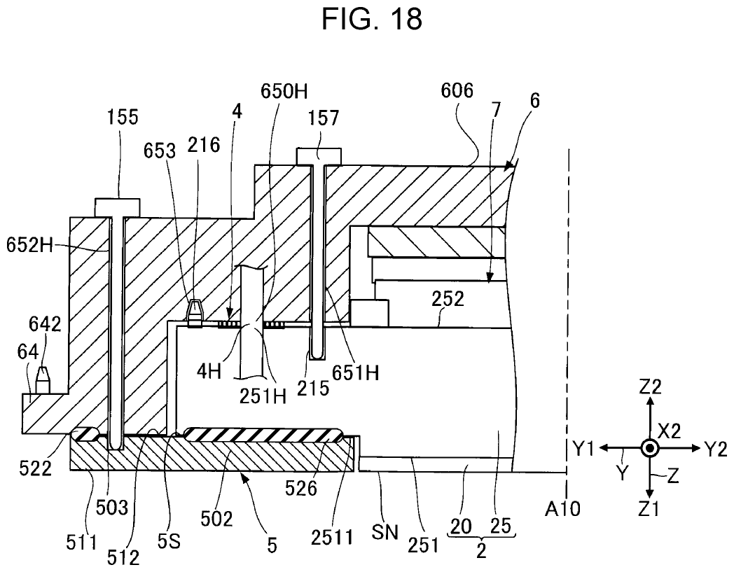

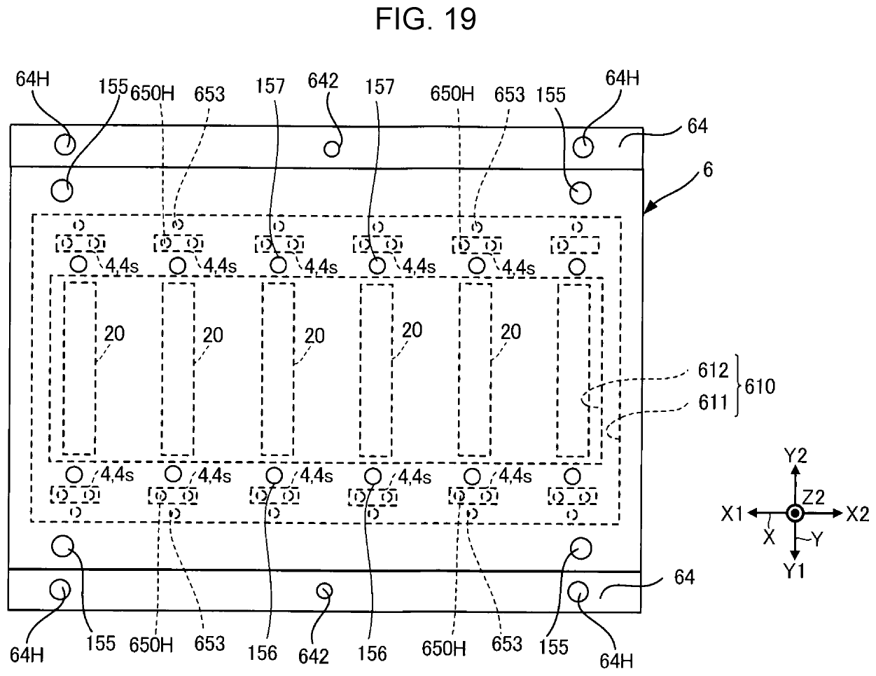

FIG. 18 is a cross-sectional view of a part of a liquid ejecting head 1 in a seventh modification. FIG. 19 is a topside view of the liquid ejecting head 1 in the seventh modification. In the seventh modification illustrated in FIG. 18, a positional relationship of the fixing members 157 and the seal members 4 with the chip 20 is different. The minimum distance between the fixing member 157 and the chip 20 is shorter than the minimum distance between the seal member 4 and he chip 20.

As illustrated in FIG. 19, the fixing members 157 are arranged between the chips 20 and the seal areas 4S so as not to overlap the chips 20 as viewed in the Z1 direction. This arrangement is likely to generate the reaction force outside the fixing members 157 as viewed from the chips 20. Therefore, the reaction force of the seal members 4 can be made particularly unlikely to be transmitted to the chips 20.

### 2-8. Eighth Modification

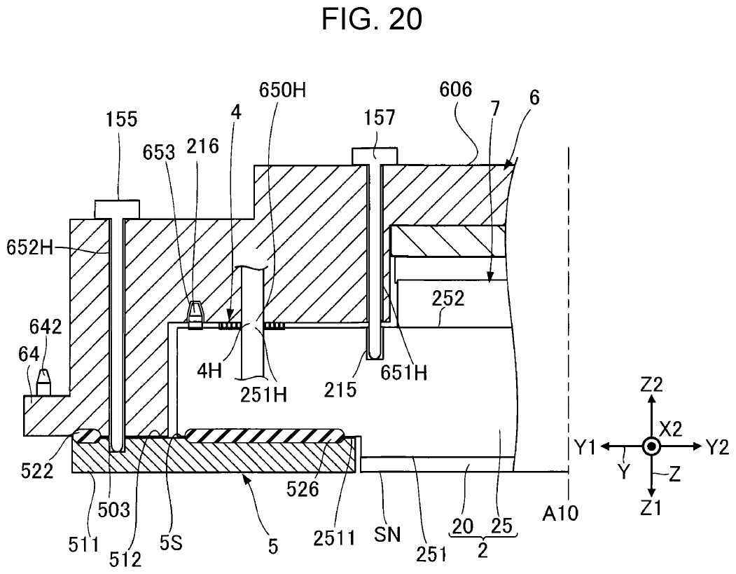

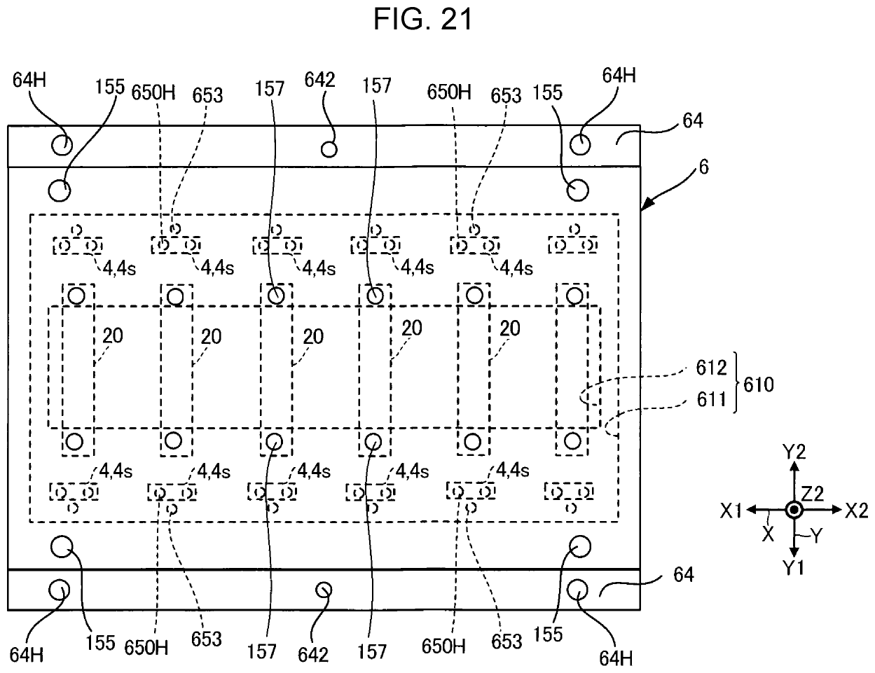

FIG. 20 is a cross-sectional view of a part of a liquid ejecting head 1 in an eighth modification. FIG. 21 is a topside view of the liquid ejecting head 1 in the eighth modification. In the eighth modification illustrated in FIGS. 20 and 21, the fixing members 157 overlap the chips 20 as viewed in the Z1 direction. Even when the fixing members 157 overlap the chips 20 as viewed in the Z1 direction, the presence of the cover 5 may reduce the influence of the reaction force of the seal members 4 on the chips 20 as compared with the case where the cover 5 is absent.

### 2-9. Ninth Modification

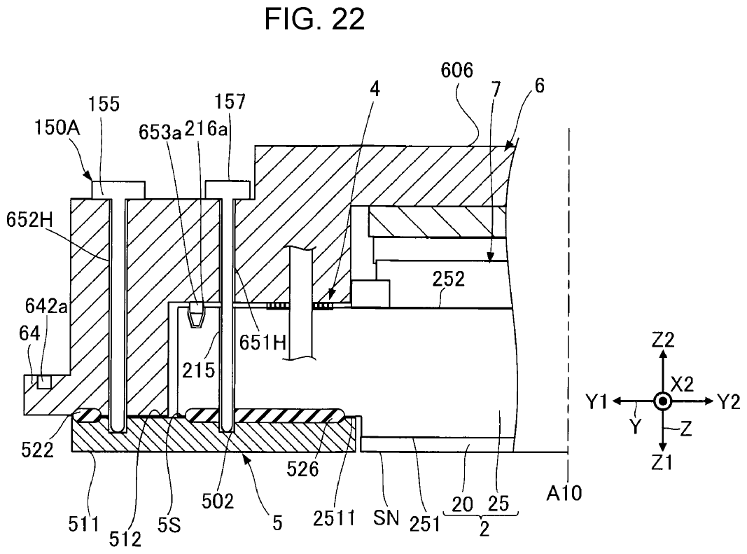

FIG. 22 is a cross-sectional view of a part of a liquid ejecting head 1 in a ninth modification. In the liquid ejecting head 1 in the ninth modification illustrated in FIG. 22, a first alignment portion 216a is a bottomed slot opened in the Z2 direction of the head module 2. The first alignment portion 216a may be regarded as a dented portion formed in the Z2 direction of the head module 2. A second alignment portion 653a is a protrusion protruding in the Z1 direction from the surface of the holder 6 facing in the Z1 direction. The second alignment portion 653a is press-fitted into the first alignment portion 216a to position the head module 2 with respect to the holder 6.

Even such first alignment portion 216a and second alignment portion 653a also enable easy positioning for attaching each head module 2 to the holder 6 as in the first embodiment. Moreover, the alignment of the multiple head modules 2 with the holder 6 can be made with high precision. In addition, in order to replace only some of the multiple head modules 2, there is no need to realign all the head modules 2.

As described in the first embodiment and the ninth modification, the multiple head modules 2 can be aligned with each other with high precision in the simple method including press-fitting either the second alignment portions 653a or the first alignment portions 216a into the other alignment portions.

The fourth alignment portion 642a is a bottomed slot opened in the surface of the flange portion 64 facing in the Z2 direction. The fourth alignment portion 642a is a dented portion, in other words, a recess, formed in the flange portion 64 in the Z1 direction. Although not illustrated, a third alignment portion 102 in this case is formed as a protruding pin provided to the unit base 11. In the fourth alignment portion 642a, the above third alignment portion 102 is press-fitted to position the liquid ejecting head 1 with respect to the unit base 11. Therefore, it is possible to improve the precision of alignment of the multiple liquid ejecting heads 1 with the unit base 11.

### 2-10. Tenth Modification

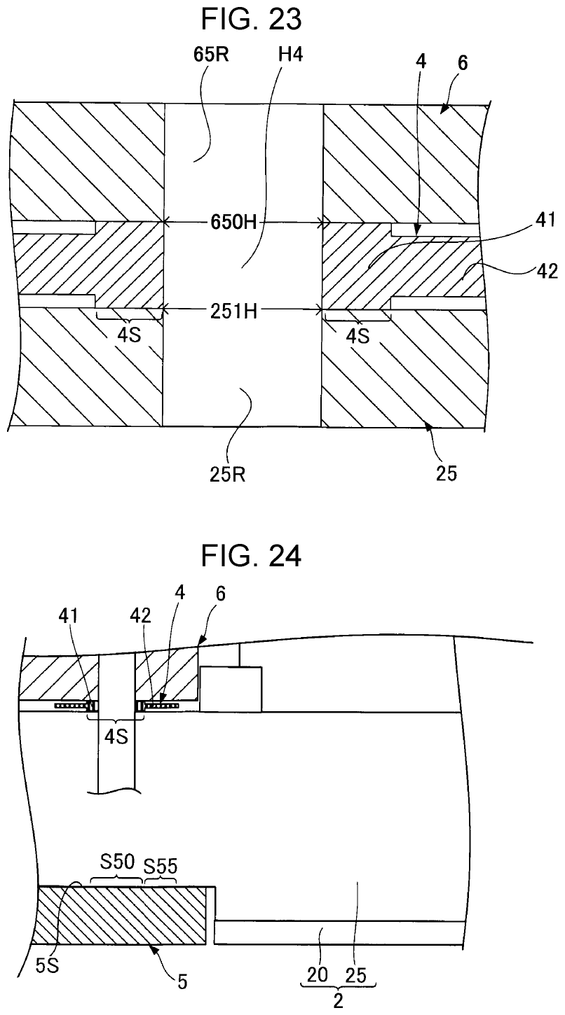

FIG. 23 is a cross-sectional view illustrating a seal member 4 and its surrounding area in a tenth modification. FIG. 24 is a cross-sectional view of a part of a liquid ejecting head 1 in the tenth modification. In the tenth modification illustrated in FIG. 23, the thickness of the seal member 4 is not constant. The seal member 4 in the tenth modification includes a thick portion 41 and a thin portion 42. The thick portion 41 is located near an inner wall surface forming the communication orifice 4H and is thicker than the thin portion 42. The thin portion 42 is located outside the thick portion 41.

In the case of the tenth modification, the thick portion 41 in the seal member 4 has the seal area 4S. The thick portion 41 is in contact with the channel orifice forming member 25 and the holder 6, and is held between the channel orifice forming member 25 and the holder 6.

As illustrated in FIG. 24, the support area 5S includes an area S55 arranged between the seal area 4S and the chip 20 as viewed in the Z1 direction. This structure can reduce the influence of the reaction force of the seal member 4 on the chip 20 as compared with the case where the support area 5S does not include the area S55.

However, the area S55 does not have to be provided. The support area 5S and the seal area 4S may be located at completely the same position in the plan view.

### 2-11. Eleventh Modification

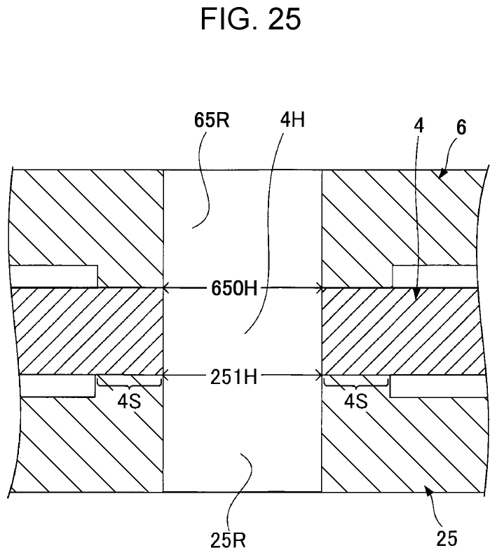

FIG. 25 is a cross-sectional view illustrating a seal member 4 and its surrounding area in an eleventh modification. In the eleventh modification illustrated in FIG. 25, the seal member 4 includes a portion out of contact with both the holder 6 and the channel orifice forming member 25. In the eleventh modification, a portion of the seal member 4 near the communication orifice 4H serves as the seal area 4S. As described above, depending on the shapes of the holder 6 and the channel orifice forming member 25, the seal member 4 may include a portion that is out of contact with both the holder 6 and the channel orifice forming member 25 and that is not held between the holder 6 and the channel orifice forming member 25. In the seal member 4, the portion held between the holder 6 and the channel orifice forming member 25 serves as the seal area 4S.

### 2-12. Other Modifications

In addition, for example, the holder 6 may be provided with a through hole formed only for use to release the press-fits between the first alignment portions 216 and the second alignment portions 653. For example, the above through hole may be a hole that passes through the holder 6 in directions in which the first alignment portions 216 are inserted into and removed from the second alignment portions 653 and that has a larger opening area than the opening area of the fixing hole 651H.

In the above description, the seal members 4 are provided for each head module 2, but a single seal member 4 may be provided in common to the multiple head modules 2.

The “first alignment portion” and the “second alignment portion” are not limited to the structures described in the above embodiments and modifications, as long as one of these portions is press-fitted into the other.

The “liquid ejecting apparatus” may be used in a variety of apparatuses, including facsimile machines and copy machines, in addition to apparatuses dedicated to printing. The use of the liquid ejecting apparatus is not limited to printing. For example, a liquid ejecting apparatus to eject a solution of a pigment may be used as a manufacturing apparatus to form color filters of display devices such as liquid display panels. Instead, a liquid ejecting apparatus to eject a solution of a conductive material may be used as a manufacturing apparatus to form wiring and electrodes for relay substrates. Alternatively, a liquid ejecting apparatus to eject a solution of an organic substance related to living organisms may be used as a manufacturing apparatus to produce, for example, bio chips.

The present disclosure is described above based on the preferred embodiments, but should not be limited to the above embodiments. The structure of each component of the present disclosure may be replaced with any structure having the same function as in the above embodiments, or any structure may be added as needed.

What is claimed is:

1. A liquid ejecting head comprising:
a plurality of head modules each of which ejects a liquid in a first direction; and
a metallic holder to which the plurality of head modules are fixed in a detachably-attached manner, wherein
each of the plurality of head modules includes a metallic channel orifice forming member in which a channel is defined, and which includes a first alignment portion,
the holder includes a plurality of second alignment portions which are inserted into or receive a plurality of the first alignment portions in a press-fit manner, thereby positioning the plurality of head modules with respect to the holder, and
a channel orifice formed in the holder and configured to make a channel-forming connection to each of the head modules and a channel orifice formed in the channel orifice forming member of the head module and configured to make the channel-forming connection to the holder coincide with each other as viewed in a direction in which either of the first alignment portions and the second alignment portions are press-fitted into the other alignment portions.

2. The liquid ejecting head according to claim 1, wherein the holder includes a member in which both of the plurality of second alignment portions and one or more channels which communicate with the plurality of head modules are formed.

3. The liquid ejecting head according to claim 1, wherein each of the plurality of head modules includes one nozzle plate.

4. The liquid ejecting head according to claim 1, wherein
the first alignment portion is provided in a surface of the channel orifice forming member facing in a second direction opposite to the first direction, and
the plurality of second alignment portions are provided in a surface of the holder facing in the first direction.

5. The liquid ejecting head according to claim 4, wherein
each of the head modules includes a chip arranged in the first direction relative to the channel orifice forming member, and
the first alignment portion does not overlap the chip as viewed in the first direction.

6. The liquid ejecting head according to claim 4, wherein
the holder includes a dented portion whose bottom surface is the surface in which the plurality of second alignment portions are arranged, and
the liquid ejecting head further comprises a cover that is fixed in contact with an outer peripheral wall of the dented portion and that includes a plurality of openings from which the plurality of head modules are respectively exposed to outside.

7. The liquid ejecting head according to claim 1, wherein
the holder includes a common channel member including one or more channels that communicate with the plurality of head modules,
the common channel member is arranged in a second direction relative to the plurality of head modules, the second direction being opposite to the first direction, and overlaps the plurality of head modules as viewed in the first direction, and
the first alignment portion is provided in a surface of the channel orifice forming member facing in the second direction.

8. The liquid ejecting head according to claim 1, further comprising a relay substrate that is electrically connected to the plurality of head modules, wherein
the relay substrate is arranged in a second direction relative to the plurality of head modules, the second direction being opposite to the first direction, and overlaps the plurality of head modules as viewed in the first direction, and
the first alignment portion is provided in a surface of the channel orifice forming member facing in the second direction.

9. The liquid ejecting head according to claim 1, wherein
the first alignment portion is arranged in a surface of the channel orifice forming member facing in the first direction,
the second alignment portions are arranged in a surface of the holder facing in a second direction opposite to the first direction,
the holder includes a plurality of openings from which the plurality of head modules are respectively exposed to outside, and
a part of the channel orifice forming member is inserted in each of the openings of the holder.

10. The liquid ejecting head according to claim 1, further comprising a plurality of first fixing members that fix the plurality of head modules to the holder in a detachably-attached manner, wherein
the holder includes a plurality of first fixing holes that pass through the holder in the first direction,
the channel orifice forming member includes a first fixing slot in a dented shape having a bottom surface,
the plurality of second alignment portions are arranged in a surface of the holder facing in the first direction,
the first alignment portion is provided in a surface of the channel orifice forming member facing in a second direction opposite to the first direction, and
each of the first fixing members is inserted in the first direction into one of the first fixing holes and one of the first fixing slots in this order.

11. The liquid ejecting head according to claim 10, wherein a depth of the first fixing hole is greater than a depth of the first fixing slot.

12. The liquid ejecting head according to claim 10, wherein the first fixing member is a screw.

13. A liquid ejecting apparatus comprising:
a plurality of the liquid ejecting heads according to claim 1; and
a unit base which holds the plurality of liquid ejecting heads.

14. The liquid ejecting head according to claim 1, wherein the holder includes a plurality of fourth alignment portions each of which is inserted into or receives one of a plurality of third alignment portions provided to a unit base which holds the plurality of liquid ejecting heads, thereby positioning the liquid ejecting head with respect to the unit base.

15. A liquid ejecting apparatus comprising:
a plurality of the liquid ejecting heads according to claim 14; and
a unit base which includes the plurality of third alignment portions and holds the plurality of liquid ejecting heads.
